(19) United States
(12) Patent Application Publication
(10) Pub. No.: US 2023/0281270 A1
(43) Pub. Date: Sep. 7, 2023

(54) RECORDING MEDIUM AND INFORMATION PROCESSING METHOD

(71) Applicant: Fujitsu Limited, Kawasaki-shi (JP)

(72) Inventor: MAKIKO ITO, Kawasaki (JP)

(73) Assignee: Fujitsu Limited, Kawasaki-shi (JP)

(21) Appl. No.: 18/071,275

(22) Filed: Nov. 29, 2022

(30) Foreign Application Priority Data
Mar. 2, 2022 (JP) 2022-032173

(51) Int. Cl. G06F 17/16; G06F 9/30

(52) U.S. Cl. CPC G06F 17/16; G06F 9/3001

(57) ABSTRACT

A computer-readable recording medium stores therein an information processing program executable by a computer, the information processing program includes: an instruction for obtaining a matrix to be subject to a calculation for a matrix vector multiplication; an instruction for generating a first matrix in a first format, the first matrix representing a first element group that includes non-zero elements among elements on a part of diagonals, among a main diagonal and sub-diagonals parallel to the main diagonal in the obtained matrix; and an instruction for generating a second matrix in a second format different from the first format, the second matrix representing a second element group that includes the non-zero elements, among the elements in at least a part of rows or columns that form the obtained matrix, other than the elements on the part of the diagonals.

### CROSS REFERENCE TO RELATED APPLICATIONS

This application is based upon and claims the benefit of priority of the prior Japanese Patent Application No. 2022-032173, filed on Mar. 2, 2022, the entire contents of which are incorporated herein by reference.

### FIELD

Embodiments discussed herein relate to information processing.

### BACKGROUND

In a case where a linear equation represented by b=Ax, where b and x are vectors and A is a matrix, is conventionally solved using an iterative solution technique, calculation for a matrix vector multiplication is repeatedly executed. The matrix A tends to be sparse. According to a technique called “prefetch”, a future access destination in a memory is presumed, data present at the access destination is read from the memory into a cache prior to issuance of a read command for the data, thereby facilitating improvement of the processing speed.

According to a prior art, for example, a matrix is split into small matrices corresponding to the number of the observed elements and a storage format of each of the small matrices is selected based on the position of each of non-zero elements. According to another technique, for example, a matrix is separated into a dense portion and a sparse portion, compression is executed for the dense portion, and compression is executed for the sparse portion. According to yet another technique, for example, a matrix is split to be matched with the size of a dedicated unit and is expressed in a format of a compressed sparse row (CSR) or the like. For examples of such techniques, refer to Japanese Laid-Open Patent Publication No. 2013-127735, International Publication No. WO 2019/155556, and U.S. Patent Application Publication No. 2020/0159810.

### SUMMARY

According to an aspect of an embodiment, a computer-readable recording medium stores therein an information processing program executable by a computer, the information processing program includes: an instruction for obtaining a matrix to be subject to a calculation for a matrix vector multiplication; an instruction for generating a first matrix in a first format, the first matrix representing a first element group that includes non-zero elements among elements on a part of diagonals, among a main diagonal and sub-diagonals parallel to the main diagonal in the obtained matrix; and an instruction for generating a second matrix in a second format different from the first format, the second matrix representing a second element group that includes the non-zero elements, among the elements in at least a part of rows or columns that form the obtained matrix, other than the elements on the part of the diagonals.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram depicting an example of an information processing method according to an embodiment.

FIG. 2 is an explanatory diagram depicting an example of an information processing system 200.

FIG. 3 is a block diagram of an example of a hardware configuration of an information processing device 100.

FIG. 4 is a block diagram depicting an example of a functional configuration of the information processing device 100.

FIG. 5 is an explanatory diagram depicting an example where a matrix is expressed in a DIA format.

FIG. 6 is an explanatory diagram depicting an example where a matrix is expressed in an ELL format.

FIG. 7 is an explanatory diagram depicting another example where a matrix is expressed in the ELL format.

FIG. 8 is an explanatory diagram depicting an example where a matrix is expressed in a CSR format.

FIG. 9A is an explanatory diagram depicting a flow of operation of the information processing device 100.

FIG. 9B is an explanatory diagram depicting the flow of the operation of the information processing device 100.

FIG. 10 is an explanatory diagram depicting the flow of the operation of the information processing device 100.

FIG. 11 is an explanatory diagram depicting an example where a matrix in the DIA format is generated.

FIG. 12 is an explanatory diagram depicting the example where a matrix in the DIA format is generated.

FIG. 13 is an explanatory diagram depicting the example where a matrix in the DIA format is generated.

FIG. 14 is an explanatory diagram depicting another example where a matrix in the DIA format is generated.

FIG. 15 is an explanatory diagram depicting another example where a matrix in the DIA format is generated.

FIG. 16 is an explanatory diagram depicting another example where a matrix in the DIA format is generated.

FIG. 17 is an explanatory diagram depicting another example where a matrix in the DIA format is generated.

FIG. 18 is an explanatory diagram depicting an example of an access pattern.

FIG. 19 is an explanatory diagram depicting an example of the access pattern.

FIG. 20 is an explanatory diagram depicting an example of the access pattern.

FIG. 21 is an explanatory diagram depicting an example of the prefetch.

FIG. 22 is an explanatory diagram depicting an example where a matrix in an ELL format is generated.

FIG. 23 is an explanatory diagram depicting a specific example of a calculation for a matrix vector multiplication.

FIG. 24 is an explanatory diagram depicting a specific example of the calculation for the matrix vector multiplication.

FIG. 25 is a flowchart depicting an example of an overall process procedure.

FIG. 26 is a flowchart depicting an example of a calculation process procedure.

### DESCRIPTION OF THE INVENTION

First, problems associated with the traditional techniques are discussed. It is difficult to efficiently execute calculation of a matrix vector multiplication. For example, in the calculation for a matrix vector multiplication called a sparse matrix and vector product (SpMV) including a sparse matrix, access destinations in a memory may be irregular and improvement of the processing speed by the prefetch may be difficult.

Embodiments of the invention are described in detail with reference to the accompanying drawings.

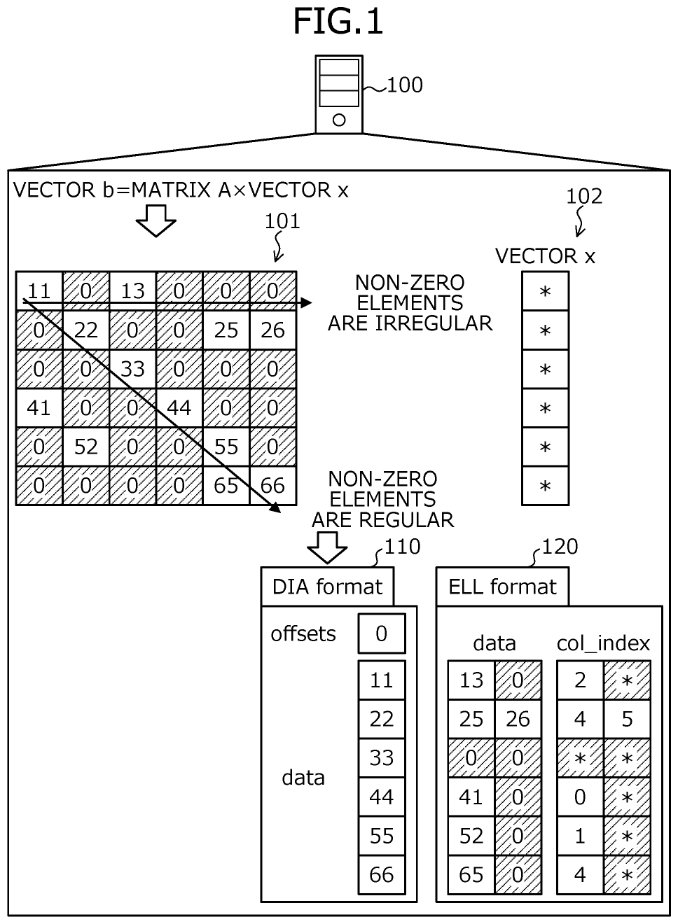

FIG. 1 is an explanatory diagram depicting an example of an information processing method according to an embodiment. An information processing device 100 is a computer configured to facilitate more efficient calculation for a matrix vector multiplication. The information processing device 100 is, for example, a server or a personal computer (PC). The information processing device 100 may have a function of a superscalar processor.

The calculation for a matrix vector multiplication may be repeatedly executed in a case where a linear equation represented by b=Ax, where b and x are vectors and A is a matrix is solved using, for example, an iterative solution technique. The matrix A may be sparse. Being sparse indicates that a relatively small number of non-zero elements are present. The matrix A may include relatively many non-zero elements on its main diagonal or on its sub-diagonals that are parallel to the main diagonal and that are relatively close to the main diagonal. The vector x may not be sparse. A linear equation is used, for example, when each of problems in various fields is expressed.

For example, a random value is first set as each of the elements of the vector x. A series of processes are thereafter repeatedly executed such as those in which calculation for the matrix vector multiplication of the matrix A and the vector x is executed, and the elements of the vector x are updated based on a result of a comparison between the result of the calculation and the vector b.

The calculation for the matrix vector multiplication is executed by reading the elements of the vector x by which the non-zero elements of the matrix A are to be multiplied and multiplying the non-zero elements of the matrix A by the read elements of the vector x. A column index corresponding to an i-th column is, for example, “i”. The column number is assigned from, for example, the number “0”. As a result, the elements of the vector x are updated such that the elements of the vector x become close to their true values.

As described above, the calculation for the matrix vector multiplication of the matrix A and the vector x may be repeatedly executed. Thus, it may be considered that, for solving a linear equation, the rate accounted for by the processing time period necessary for the calculation for a matrix vector multiplication is relatively large relative to the overall processing time period necessary for solving the linear equation. The calculation for matrix vector multiplication is also called “SpMV” in the case where the matrix A is sparse.

According to the technique called “prefetch”, a future access destination in a memory is presumed and data present at the access destination is read from the memory into a cache prior to issuance of a read command for the data, whereby improvement of the processing speed is facilitated. According to a technique called “single instruction/multiple data (SIMD)”, plural pieces of data are processed in parallel.

For example, the prefetch technique is also applied to the calculation for a matrix vector multiplication. For example, it may be considered that the above calculation for a matrix vector multiplication is executed using the SIMD. For example, it may be considered that active use of the prefetch is tried in reading the elements of the vector x by which the non-zero elements of the matrix A are to be multiplied and multiplying thereby the non-zero elements of the matrix A based on the column indexes of the non-zero elements of the matrix A using the SIMD.

Nonetheless, it is conventionally difficult to efficiently execute the calculation for a matrix vector multiplication. For example, in the calculation for the matrix vector multiplication called SpMV, access destinations in a memory are irregular and it is difficult to facilitate improvement of the processing speed using the prefetch.

For example, in a case where the non-zero elements are extracted in the row direction or the column direction in the matrix A, the column indexes of the extracted non-zero elements irregularly vary, and the elements of the vector x to be read are therefore consequently also irregular. It is therefore difficult to presume in advance the element of the vector x to be read next and to copy this element in a cache, and it is therefore difficult to facilitate improvement of the processing speed using the prefetch.

Such approaches may be considered as one to try to facilitate reduction of the use amount of the memory that stores the matrix A by representing the matrix A in a predetermined format, or as one to facilitate more efficient calculation for a matrix vector multiplication. For example, an approach may be considered such as an approach of representing the matrix A in a diagonal (DIA) format, an approach of representing the matrix A in an ellpack (ELL) format, or an approach of representing the matrix A in a CSR format. For these approaches, for example, Benatia, Akrem, et al., “Best SF: a sparse meta-format for optimizing SpMV on GPU.”, ACM Transactions on Architecture and Code Optimization (TACO), 15.3 (2018): 1-27 may be referred to. It may still be difficult to efficiently execute the calculation for a matrix vector multiplication using any of these approaches.

In the present embodiment, an information processing method capable of facilitating more efficient calculation for a matrix vector multiplication is described.

In FIG. 1, (1-1) the information processing device 100 obtains a matrix 101 for which matrix vector multiplication is performed. The calculation for the matrix vector multiplication is, for example, matrix vector multiplication of the matrix A and the vector x executed when linear equation “b=Ax” for vector b is solved. The matrix 101 has, for example, N rows and N columns. In the example depicted in FIG. 1, N=6. The matrix 101 corresponds to, for example, the matrix A of the linear equation. The matrix 101, for example, tends to be sparse.

The matrix 101, for example, tends to include relatively many non-zero elements on a main diagonal. The main diagonal is, for example, a line connecting the element in a first row and in a first column, and the element in the N-th row and in the N-th column of the matrix 101 to each other. The matrix 101 may include relatively many non-zero elements on, for example, its main diagonal and its sub-diagonals that are parallel to the main diagonal and that are relatively close to the main diagonal. For example, the sub-diagonals are lines each connecting the element in the 1+n-th row and in the first column to the element in the N-th row and in the (N−n)-th column of the matrix 101 to each other, or lines each connecting the element in the first row and in the (1+n)-th column to the element in the (N−n)-th row and in the N-th column of the matrix 101 to each other.

In the matrix 101, the column index of each of the non-zero elements in each of the rows tends to irregularly appear. In the matrix 101, non-zero elements tend to appear being relatively dispersed in each of the rows. On the other hand, in the matrix 101, the column index of each of the non-zero elements on the main diagonal tends to regularly appear. In the matrix 101, the non-zero elements tend to relatively collectively appear on the main diagonal. In the matrix 101, the non-zero elements tend to relatively consecutively appear on the main diagonal.

It may therefore be considered that, when it is assumed that the non-zero elements on the main diagonal are extracted and the calculation is partially executed for the extracted non-zero elements on the main diagonal of the calculation for the matrix vector multiplication, the prefetch effectively works and therefore, improvement of the processing speed may be easily facilitated. Similarly, a case may also be considered where, when the calculation is partially executed for the non-zero elements on a sub-diagonal of the calculation for the matrix vector multiplication, the prefetch effectively works and the improvement of the processing speed therefore may be easily facilitated.

(1-2) The information processing device 100 generates a first matrix 110 in a first format representing an element group that includes the non-zero elements of the elements on a part of the diagonals among the main diagonal and the sub-diagonals parallel to the main diagonal in the obtained matrix 101. The part of the diagonals may be, for example, only the main diagonal. The part of the diagonals may, for example, exclude the main diagonal. The first format is, for example, the DIA format.

In the example in FIG. 1, the first matrix 110 is formed by an offsets array and a data matrix. In the offsets array, an offset value to identify any one diagonal of the main diagonal and the sub-diagonals is set as an element. “The offset value=0” indicates the main diagonal. “The offset value=−x” indicates a sub-diagonal that is the x-th one from the side close to the main diagonal, being present on the lower left side of the main diagonal. “The offset value=+x” indicates a sub-diagonal that is the x-th one from the side close to the main diagonal, being present on the upper right side of the main diagonal. In the data matrix, each element on the diagonal that is indicated by the offset value of the main diagonal and the sub-diagonals is set as an element of a column that corresponds to the diagonal.

The information processing device 100 may thereby make the first matrix 110 be usable for executing the calculation for the matrix vector multiplication such that the prefetch effectively works and the improvement of the processing speed may be easily facilitated. The information processing device 100 may make the first matrix 110 usable for executing the calculation for the matrix vector multiplication such that, for example, the calculation may be partially executed for the non-zero elements on the part of the diagonals.

(1-3) The information processing device 100 generates a second matrix 120 in a second format representing an element group that includes non-zero elements among the elements that are in at least a part of the rows or the columns that form the obtained matrix 101, other than the elements on the part of the diagonals. The second format is, for example, the ELL format. The information processing device 100 generates the second matrix 120 in the second format representing, for example, an element group that includes non-zero elements among the elements that are in the rows forming the obtained matrix 101, other than the elements on the part of the diagonals.

In the example in FIG. 1, the second matrix 120 is formed by a data matrix and a col_index matrix. In the data matrix, the non-zero element in the i-th row of the matrix 101 is set as the element in the i-th row. The row number is assigned from, for example, the number “0”. In the col_index matrix, a column index j of the j-th non-zero element in the i-th row of the matrix 101 is set as the element in the i-th row. In the example in FIG. 1, 0≤j≤1.

The information processing device 100 may thereby make the second matrix 120 usable for executing the calculation for the matrix vector multiplication such that the calculation may be partially executed for the non-zero elements in each of the rows of the matrix 101 other than the elements on the part of the diagonals. The information processing device 100 may therefore make the overall calculation for the matrix vector multiplication be executable using the first matrix 110 and the second matrix 120. The information processing device 100 may therefore make the prefetch to work effectively and may easily facilitate improvement of the processing speed when the calculation for the matrix vector multiplication is executed.

The information processing device 100 may facilitate the improvement of the processing speed for the calculation for the matrix vector multiplication and may therefore facilitate reduction of the processing amount necessary for solving the linear equation. The matrix 101 is common to the calculation for the matrix vector multiplication that is repeatedly executed for solving the linear equation. It may therefore be considered that the reduction amount of the processing amount resulting from the improvement of the processing speed of the calculation for the matrix vector multiplication is large, as compared to the increase amount of the processing amount necessary when the first matrix 110 and the second matrix 120 are generated based on the matrix 101. The information processing device 100 may therefore facilitate reduction of the processing amount necessary when the linear equation is solved.

While a case where the first format is the DIA format has been described, the first format is not limited to the above. A case may be present where the first format is, for example, a format other than the DIA format. For example, a case may be present where the first format is a subspecies format or an expanded format of the DIA format.

While a case where the second format is the ELL format has been described, the second format is not limited to the above. A case may be present where the second format is, for example, a format other than the ELL format. For example, a case may be present where the second format is a subspecies format or an expanded format of the ELL format. For example, the case may be present where the second format is the CSR format. For example, the case may be present where the second format remains as the format of the matrix 101.

While case has been descried where the information processing device 100 generates the second matrix 120 in the second format representing the element group that includes the non-zero elements on each row of all the rows forming the matrix 101, the procedure is not limited to the above. A case may be present where the information processing device 100 generates the second matrix 120 in the second format representing the element group that includes the non-zero elements in a part of the rows forming the matrix 101, and a third matrix not depicted in a third format representing an element group that includes the non-zero elements in the rest of the rows. The third format is, for example, the CSR format.

While a case where the information processing device 100 alone operates has been described, the operation is not limited to the above. A case, for example, where the information processing device 100 operates in cooperation with another computer may be present.

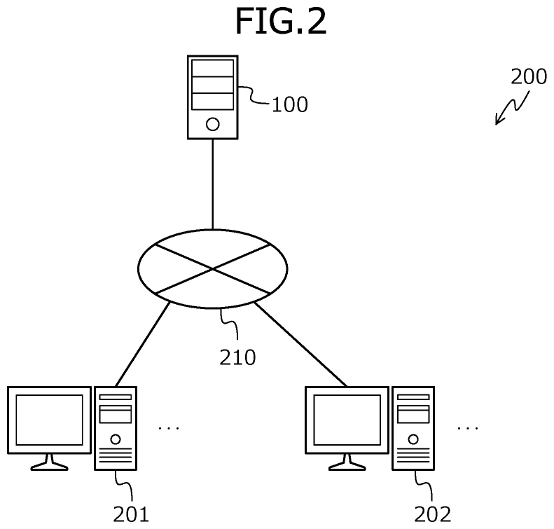

While a case, for example, where the information processing device 100 executes the calculation for the matrix vector multiplication based on the first matrix 110 and the second matrix 120 has been described, the execution is not limited to the above. A case, for example, where the information processing device 100 presents the first matrix 110 and the second matrix 120 to another computer may be present. In this case, the other computer executes the calculation for the matrix vector multiplication based on the first matrix 110 and the second matrix 120. An example where the information processing device 100 cooperates with the other computer will be described later with reference to FIG. 2.

An example of an information processing system 200 to which the information processing device 100 depicted in FIG. 1 is applied is described next with reference to FIG. 2.

FIG. 2 is an explanatory diagram depicting an example of the information processing system 200. In FIG. 2, the information processing system 200 includes the information processing device 100, a matrix calculating device 201, and a client device 202.

In the information processing system 200, the information processing device 100 and the matrix calculating device 201 are connected to each other through a wired or a radio network 210. The network 210 is, for example, a local area network (LAN), a wide area network (WAN), or the Internet. In the information processing system 200, the information processing device 100 and the client device 202 are connected to each other through the wired or the radio network 210.

The information processing device 100 receives a processing request from the client device 202. The processing request requests, for example, solving a linear equation that includes a target matrix that is to be subject to processing. The processing request includes, for example, the target matrix. The information processing device 100 obtains the target matrix. The information processing device 100, for example, extracts the target matrix from the processing request to thereby obtain the target matrix.

The information processing device 100 generates a first matrix in the DIA format, representing an element group that includes the non-zero elements on a part of the diagonals among the main diagonal and the sub-diagonals parallel to the main diagonal in the target matrix. The information processing device 100 generates a second matrix in the ELL format, representing an element group that includes the non-zero elements in a part of the rows that form the target matrix, other than the elements on the part of the diagonals. The information processing device 100 generates a third matrix in the CSR format, representing an element group that includes the non-zero elements on the rest of the rows that form the target matrix, other than the elements on the part of the diagonals.

The information processing device 100 transmits, to the matrix calculating device 201, a processing request that includes the generated first matrix in the DIA format, the generated second matrix in the ELL format, and the generated third matrix in the CSR format. The processing request requests solving the linear equation that includes the target matrix. The information processing device 100 receives the solution of the linear equation from the matrix calculating device 201 and transmits the solution to the client device 202. The information processing device 100 is, for example, a server or a PC.

The matrix calculating device 201 is a computer configured to solve the linear equation. The matrix calculating device 201 receives the processing request from the information processing device 100. The matrix calculating device 201 obtains the first matrix in the DIA format, the second matrix in the ELL format, and the third matrix in the CSR format. The matrix calculating device 201 obtains the first matrix in the DIA format, the second matrix in the ELL format, and the third matrix in the CSR format by, for example, extracting these matrixes from the processing request.

The matrix calculating device 201, in response to the processing request, repeatedly executes the calculation for the matrix vector multiplication relating to the target matrix, based on the obtained first matrix in the DIA format, the obtained second matrix in the ELL format, and the obtained third matrix in the CSR format to thereby solve the linear equation. The matrix calculating device 201 transmits the solution of the linear equation to the information processing device 100. The matrix calculating device 201 is, for example, a server or a PC.

The client device 202 is a computer used by a system user. The client device 202 transmits the processing request to the information processing device 100. The client device 202 generates the processing request based on, for example, an operational input by the system user, and transmits the processing request to the information processing device 100. The client device 202 receives the solution of the linear equation from the information processing device 100. The client device 202 outputs the solution of the linear equation so that the system user is able to refer to the solution. The client device 202 is, for example, a PC, a tablet terminal, or a smartphone.

The information processing system 200 may thereby facilitate the reduction of the processing amount necessary when the linear equation is solved and thus, may efficiently determine the solution of the linear equation. The information processing system 200 may facilitate more efficient calculation for the matrix vector multiplication by, for example, effectively using the prefetch and may therefore facilitate the reduction of the processing amount necessary when the linear equation is solved.

While a case where the information processing device 100 is a device different from the matrix calculating device 201 has been described, the information processing device 100 is not limited to the above. A case, for example, where the information processing device 100 also has the function as the matrix calculating device 201 and may also operate as the matrix calculating device 201 may be present.

While a case where the information processing device 100 is a device different from the client device 202 has been described, the information processing device 100 is not limited to the above. A case, for example, where the information processing device 100 also has the function as the client device 202 and may also operate as the client device 202 may be present.

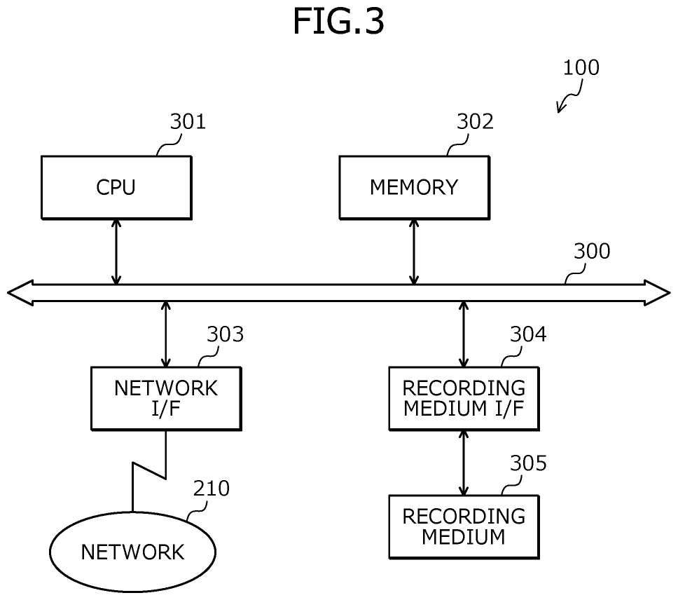

Next, with reference to FIG. 3, an example of a hardware configuration of the information processing device 100 is described.

FIG. 3 is a block diagram of an example of the hardware configuration of the information processing device 100. In FIG. 3, the information processing device 100 has a central processing unit (CPU) 301, a memory 302, a network interface (I/F) 303, a recording medium I/F 304, and a recording medium 305. Further, the components are connected to one another by a bus 300.

Here, the CPU 301 governs overall control of the information processing device 100. The memory 302 includes, for example, a read only memory (ROM), a random access memory (RAM), and a flash ROM, etc. In particular, for example, the flash ROM and the ROM store various types of programs and the RAM is used as a work area of the CPU 301. Programs stored in the memory 302 are loaded onto the CPU 301, whereby encoded processes are executed by the CPU 301.

The network I/F 303 is connected to a network 210 through a communications line and is connected to other computers via the network 210. Further, the network I/F 303 administers an internal interface with the network 210 and controls the input and output of data with respect to other computers. The network I/F 303, for example, is a modem or a LAN adapter, etc.

The recording medium I/F 304, under the control of the CPU 301, controls the reading and writing of data with respect to the recording medium 305. The recording medium I/F 304, for example, is disk drive, a solid state drive (SSD), a universal serial bus (USB) port, etc. The recording medium 305 is a non-volatile memory that stores therein data written thereto under the control of the recording medium I/F 304. The recording medium 305, for example, is a disk, a semiconductor memory, a USB memory, etc. The recording medium 305 may be removable from the information processing device 100.

The information processing device 100, in addition to the components above, may have, for example, a keyboard, a mouse, a display, a printer, a scanner, a microphone, a speaker, etc. Further, the information processing device 100 may have the recording medium I/F 304 and/or the recording medium 305 in plural. Further, the information processing device 100 may omit the recording medium I/F 304 and/or the recording medium 305.

An example of the hardware configuration of the matrix calculating device 201 is same as, for example, the example of the hardware configuration of the information processing device 100 depicted in FIG. 3 and will therefore not again be described.

An example of the hardware configuration of the client device 202 is same as, for example, the example of the hardware configuration of the information processing device 100 depicted in FIG. 3 and will therefore not again be described.

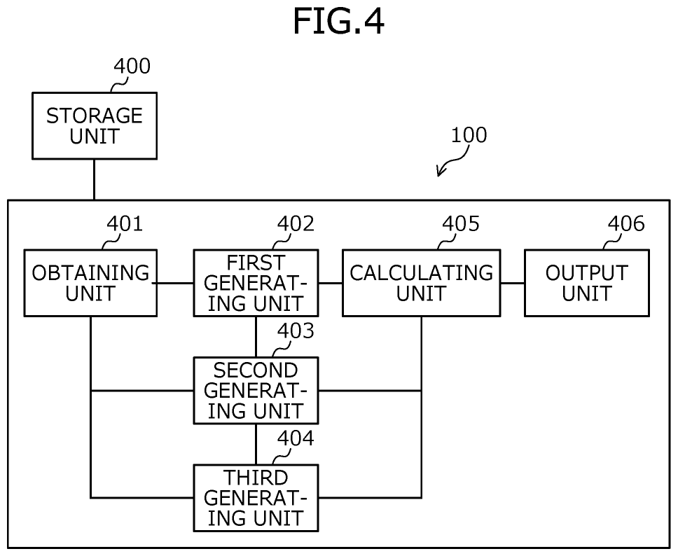

An example of a functional configuration of the information processing device 100 is described next with reference to FIG. 4.

FIG. 4 is a block diagram depicting an example of the functional configuration of the information processing device 100. The information processing device 100 includes a storage unit 400, an obtaining unit 401, a first generating unit 402, a second generating unit 403, a third generating unit 404, a calculating unit 405, and an output unit 406.

The storage unit 400 is realized by, for example, storage areas such as the memory 302 and the recording medium 305 depicted in FIG. 3. While a case where the storage unit 400 is included in the information processing device 100 is described below, the storage unit 400 is not limited to the above. A case may be present, for example, where the storage unit 400 is included in a device different from the information processing device 100 and the storage content of the storage unit 400 may be referred to from the information processing device 100.

The units from the obtaining unit 401 to the output unit 406 function as an example of a controller. The units from the obtaining unit 401 to the output unit 406 realize the functions thereof by causing the CPU 301 to execute programs stored in the storage areas such as the memory 302 and the recording medium 305 depicted in FIG. 3 or using the network I/F 303. The processing result of each of the functional units is stored, for example, in the storage areas such as the memory 302 and the recording medium 305 depicted in FIG. 3.

The storage unit 400 stores therein various types of information that are referred to or updated in the processing by each of the functional units. The storage unit 400 stores therein a target matrix of the matrix vector multiplication calculation. The matrix vector multiplication calculation is, for example, a calculation that is repeatedly executed when a linear equation is solved. The matrix vector multiplication calculation is, for example, a calculation for a matrix vector multiplication of a target matrix and a predetermined vector. The target matrix is, for example, a matrix having sparseness. The target matrix is obtained by, for example, the obtaining unit 401.

The storage unit 400 stores therein a first matrix in a first format. The first matrix represents, for example, an element group that includes the non-zero elements on a part of the diagonals among the main diagonal and the sub-diagonals parallel to the main diagonal in the target matrix. The first matrix represents, for example, each of the elements of the element group so that the position of the element in the target matrix is identifiable.

The first matrix may represent, for example, an element group that includes the non-zero elements on a part of the diagonals of the main diagonal and a first number of sub-diagonals that are parallel to the main diagonal and that are relatively close to the main diagonal. The first number is, for example, set by a user in advance. The first matrix may represent, for example, an element group that includes the non-zero elements on a part of the diagonals whose numbers of the non-zero elements are each smaller than a second number, among the main diagonal and the sub-diagonals that are parallel to the main diagonal. The second number is, for example, set by the user in advance.

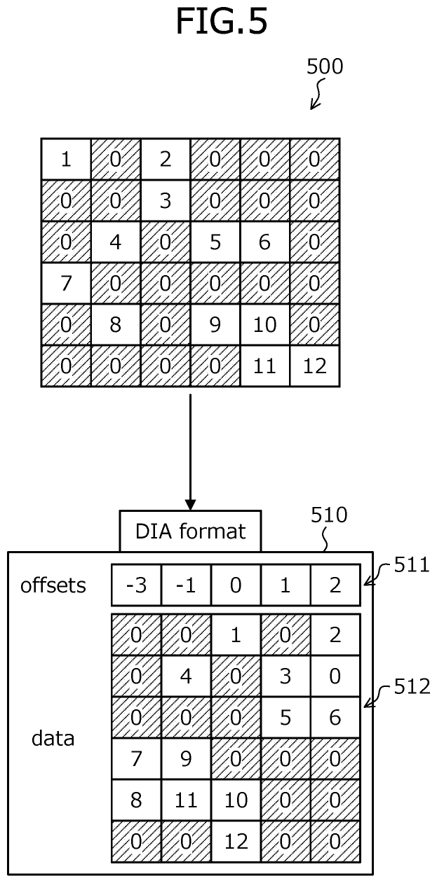

The first format is, for example, a format that represents an element group including the non-zero elements on the part of the diagonals. The first format is, for example, the DIA format. A specific example of the DIA format is described later with reference to, for example, FIG. 5. The first matrix is generated by, for example, the first generating unit 402.

The storage unit 400 stores therein a second matrix in a second format. The second matrix represents, for example, an element group that includes the non-zero elements in at least a part of the rows or the columns that form the target matrix, other than the elements on the afore-mentioned part of the diagonals. The second matrix represents, for example, each element of the element group so that the position of the element is identifiable.

The second matrix may represent, for example, an element group that includes the non-zero elements in a part of the rows or the columns whose numbers of the non-zero elements are each smaller than a third number and that forms the target matrix, other than the elements on the above part of the diagonals. The third number is, for example, set by the user in advance.

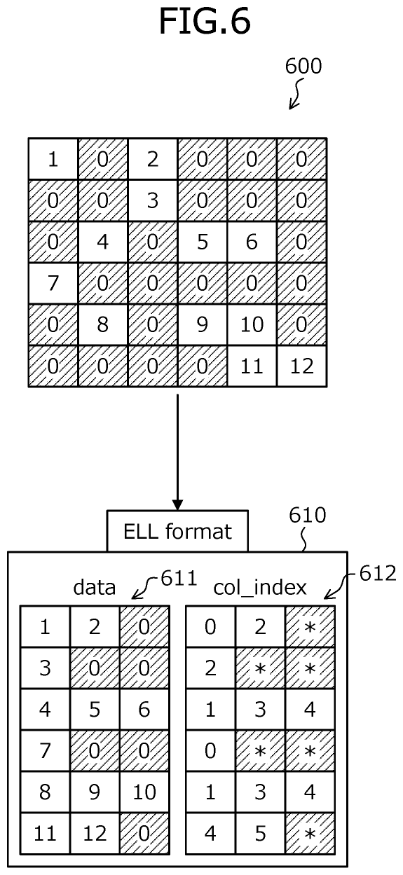

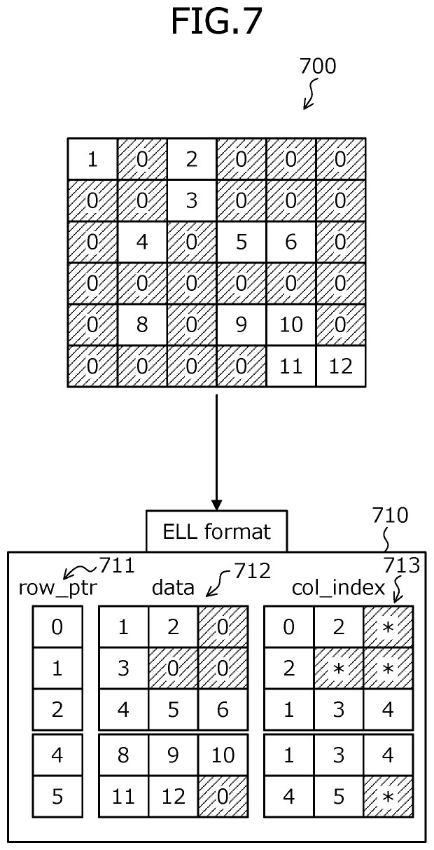

The second format is, for example, a format different from the first format. The second format represents, for example, an element group that includes the non-zero elements in the part of the rows or the columns along the rows or the columns. The second format is, for example, the ELL format. A specific example of the ELL format is described later with reference to, for example, FIG. 6 and FIG. 7. The second matrix is generated by, for example, the second generating unit 403.

The storage unit 400 stores therein a third matrix in a third format. The third matrix represents, for example, an element group that includes the non-zero elements in the rest of the rows or the columns except the afore-mentioned part of the rows or the columns, among the plural rows or columns that form the target matrix, other than the elements on the above part of the diagonals. The third matrix represents, for example, each element of the element group so that the position of the element is identifiable.

The third matrix may represent, for example, an element group that includes the non-zero elements in a part of the rows or the columns whose numbers of the non-zero elements are at least each equal to the third number and that forms the target matrix, other than the elements on the above part of the diagonals.

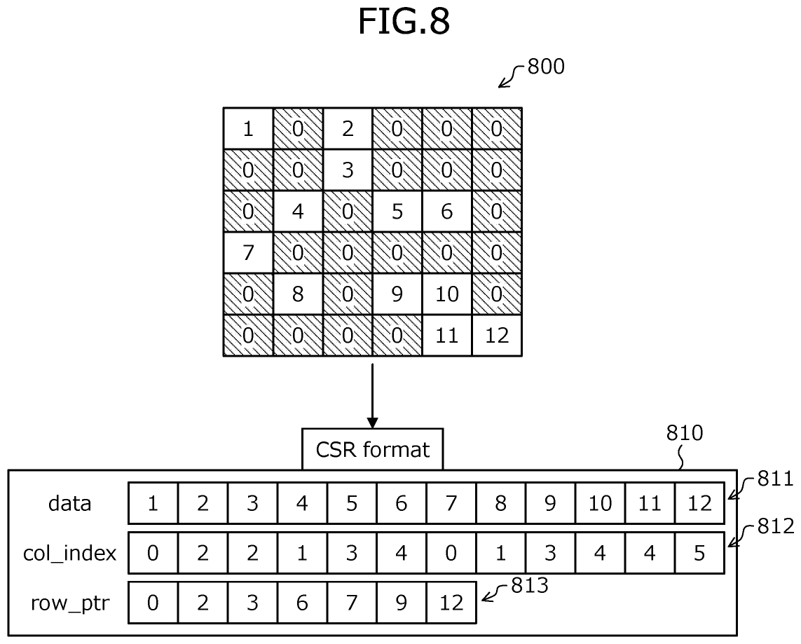

The third format is, for example, a format different from the first format and the second format. The third format represents, for example, an element group that includes the non-zero elements in the rest of the rows or the columns, along the rows or the columns. The third format is, for example, the CSR format. A specific example of the CSR format is described later with reference to, for example, FIG. 8. The third matrix is generated by, for example, the third generating unit 404.

The target matrix is thus expressed by a combination of the first matrix, and at least any one of the second matrix and the third matrix.

The obtaining unit 401 obtains various types of information to be used in the processing by each of the functional units. The obtaining unit 401 stores the obtained various types of information in the storage unit 400, or outputs the various types of information to each of the functional units. The obtaining unit 401 may output the various types of information stored in the storage unit 400, to each of the functional units. The obtaining unit 401 obtains the various types of information based on, for example, an operational input by the user. The obtaining unit 401 may receive the various types of information from, for example, a device different from the information processing device 100.

The obtaining unit 401 obtains the target matrix. The obtaining unit 401 obtains the target matrix by, for example, receiving the target matrix from another computer. The other computer is, for example, the client device 202. The obtaining unit 401 may obtain the target matrix by, for example, receiving input of the target matrix, based on an operational input by the user.

The obtaining unit 401 may receive a start trigger for starting processing by any of the functional units. The start trigger is, for example, execution of a predetermined operational input by the user. The start trigger may also be, for example, reception of predetermined information from another computer. The start trigger may also be, for example, output of the predetermined information by any of the functional units. The obtaining unit 401 obtains, for example, the target matrix as a start trigger for starting processing by each of the first generating unit 402, the second generating unit 403, the third generating unit 404, and the calculating unit 405.

The first generating unit 402 generates the first matrix in the first format, based on the target matrix obtained by the obtaining unit 401. The first generating unit 402 generates the first matrix in the first format that represents, for example, an element group including the non-zero elements of the elements on a part of the diagonals among the main diagonal and the sub-diagonals parallel to the main diagonal in the target matrix. The first generating unit 402 generates the first matrix in the DIA format that represents, for example, the value and the position of each of the non-zero elements on a part of the diagonals in the target matrix, to be identifiable. The first generating unit 402 may thereby make the calculation for the matrix vector multiplication be more efficient. The first generating unit 402 may make a portion of the calculation for the matrix vector multiplication be executable.

The first generating unit 402 may also generate the first matrix in the first format that represents, for example, an element group including the non-zero elements among the elements on a part of the diagonals of the main diagonal and the first number of sub-diagonals that are parallel to the main diagonal and that are relatively close to the main diagonal in the target matrix. The first generating unit 402 may thereby limit the number of the sub-diagonals to be processed and may thus facilitate the reduction of the processing amount. The first generating unit 402 may facilitate the reduction of the processing amount while being able to maintain more efficient calculation for the matrix vector multiplication when the non-zero elements in the target matrix have a tendency for appearing on the main diagonal or the sub-diagonals relatively close to the main diagonal. The first generating unit 402 may make a portion of the calculation for the matrix vector multiplication be executable.

The first generating unit 402 may also generate the first matrix in the first format that represents, for example, an element group including the non-zero elements among the elements on a part of the diagonals whose numbers of the non-zero elements are each smaller than the second number, among the main diagonal and the sub-diagonals parallel to the main diagonal in the target matrix. The first generating unit 402 may thereby identify the part of the diagonals on which are the non-zero elements with which the calculation for the matrix vector multiplication tends to be more efficient, and the first generating unit 402 may make the calculation for the matrix vector multiplication be more efficient. The first generating unit 402 may make a portion of the calculation for the matrix vector multiplication be executable.

The part of the diagonals may include, for example, plural diagonals that are classified into different groups. In the groups, for example, the diagonals that are each determined to include relatively many non-zero elements may be classified in advance. The first generating unit 402 may generate the first matrix in the first format that represents, for example, for each of the groups, an element group including the non-zero elements of the elements on the diagonals that are classified in the group. The first generating unit 402 may thereby make a portion of the calculation for the matrix vector multiplication be executable for each of the diagonals on which are the non-zero elements with which the calculation for the matrix vector multiplication may be more efficient.

The second generating unit 403 generates the second matrix in the second format, based on the target matrix obtained by the obtaining unit 401. The second generating unit 403 generates the second matrix in the second format that is different from the first format, and that, for example, represents an element group including the non-zero elements of the elements in at least a part of the rows or the columns that form the target matrix, other than the elements on the part of the diagonals. The second generating unit 403 generates the second matrix in the ELL format that represents, for example, the value and the position of each of the non-zero elements in the part of the rows in the target matrix, to be identifiable. The second generating unit 403 may generate the second matrix in a subspecies of the ELL format that represents, for example, the value and the position of each of the non-zero elements in the part of the columns in the target matrix, to be identifiable. The second generating unit 403 may thereby make a portion of the calculation for the matrix vector multiplication be executable.

The second generating unit 403 may, for example, divide the target matrix in the column direction and identify plural submatrices obtained by splitting the target matrix in the column direction. The second generating unit 403 may generate the second matrix in the second format that represents, for example, for each submatrix included in the plural submatrices, an element group including the non-zero elements in at least a part of the rows forming the submatrix, other than the elements on the part of the diagonals. The second generating unit 403 generates the second matrix in the ELL format that represents in an identifiable manner, for example, for each submatrix, the value and the position of each of the non-zero elements in a part of the rows in the submatrix. The second generating unit 403 may thereby make a portion of the calculation for the matrix vector multiplication be executable. The second generating unit 403 may make the cache easy to use and may make the calculation for the matrix vector multiplication be more efficient.

The second generating unit 403 may search for, for example, a part of the rows or the columns whose numbers of the non-zero elements are each smaller than the third number, other than the elements on the part of the diagonals. The second generating unit 403 may generate the second matrix in the second format that represents, for example, an element group that includes the non-zero elements among the elements in a part of the rows or the columns that are searched and that form the target matrix, other than the elements on the part of the diagonals. The second generating unit 403 may thereby make a portion of the calculation for the matrix vector multiplication be executable. The second generating unit 403 may make the cache easy to use and may make the calculation for the matrix vector multiplication be more efficient.

The second generating unit 403 generates the second matrix in the second format to, for example, not include, in the rows or the columns forming the second matrix, any row or any column that represents any of the elements in the rows or the columns that each have no non-zero element present therein and that form the target matrix. The second generating unit 403 may thereby facilitate reduction of the use amount of the memory to store therein the second matrix.

The second generating unit 403 may generate the second matrix in the second format that represents, for example, an element group including the non-zero elements of the elements in all the rows or the columns that form the target matrix, other than the elements on the part of the diagonals. The second generating unit 403 may thereby make a portion of the calculation for the matrix vector multiplication be executable.

The third generating unit 404 generates a third matrix in a third format, based on the target matrix obtained by the obtaining unit 401. The third generating unit 404 generates the third matrix in the third format that represents, for example, an element group that includes the non-zero elements among the elements in the rest of the rows or the column that are not to be processed by the second generating unit 403, the target matrix being formed by elements other than the elements on the part of the diagonals. The third generating unit 404 generates the third matrix in the CSR format that represents, for example, an element group including the non-zero elements among the elements in the rest of the rows that are not to be processed by the second generating unit 403, the target matrix being formed by elements other than the elements on the part of the diagonals. The third generating unit 404 may thereby make a portion of the calculation for the matrix vector multiplication be executable.

The third generating unit 404 may generate the third matrix in the CSR format that represents, for example, an element group including the non-zero elements of the elements in the rest of the rows or the columns that are not searched for by the second generating unit 403 and form the target matrix, other than the elements on the part of the diagonals. The third generating unit 404 generates the third matrix in the CSR format that represents, for example, an element group including the non-zero elements of the elements forming the target matrix and in a part of the rows whose numbers of the non-zero elements are each at least equal to the third number, other than the elements on the part of the diagonals. The third generating unit 404 may thereby make a portion of the calculation for the matrix vector multiplication be executable.

The calculating unit 405 executes the calculation for a matrix vector multiplication. The calculating unit 405 executes the calculation for a matrix vector multiplication, for example, based on at least the generated first matrix and the generated second matrix, using the function of prefetching a portion of a predetermined vector. The calculating unit 405 may execute the calculation for a matrix vector multiplication, for example, based on the generated first matrix, the generated second matrix, and the generated third matrix, using the function of prefetching a portion of the predetermined vector. The calculating unit 405 may thereby efficiently execute the calculation for a matrix vector multiplication.

The output unit 406 outputs the processing result of at least any of the functional units. The output format is, for example, displaying on a display, outputting for printing by a printer, transmission to an external device by the network I/F 303, or storage to a storing area such as the memory 302 or the recording medium 305. The output unit 406 may thereby notify the user of the processing result of at least any of the functional units and may thus improve the convenience of the information processing device 100.

The output unit 406 outputs, for example, the generated first matrix. The output unit 406, for example, transmits the generated first matrix to another computer capable of executing the calculation for a matrix vector multiplication. The output unit 406 may thereby cause the calculation for a matrix vector multiplication to be efficiently executable by another computer.

The output unit 406 outputs, for example, the generated second matrix. The output unit 406, for example, transmits the generated second matrix to another computer that is capable of executing the calculation for the matrix vector multiplication. The output unit 406 may thereby make the calculation for the matrix vector multiplication to be efficiently executable by the other computer.

The output unit 406 outputs, for example, the generated third matrix. The output unit 406, for example, transmits the generated third matrix to another computer that is capable of executing the calculation for the matrix vector multiplication. The output unit 406 may thereby make the calculation for the matrix vector multiplication be efficiently executable by the other computer.

The output unit 406 outputs, for example, the result of the execution of the calculation for the matrix vector multiplication. The output unit 406, for example, outputs the result of the execution of the calculation for the matrix vector multiplication to enable referencing thereof by the user. The output unit 406 may thereby make the result of the execution of the calculation for the matrix vector multiplication usable by the user.

While a case where the information processing device 100 includes the calculating unit 405 has been described, the configuration is not limited to the above. A case, for example, where the information processing device 100 does not include the calculating unit 405 may be present. In this case, preferably, for example, the information processing device 100 may be able to communicate with another computer that includes the calculating unit 405.

An example where a matrix is expressed in the DIA format is described with reference to FIG. 5.

FIG. 5 is an explanatory diagram depicting an example where a matrix is expressed in the DIA format. For example, an example where a matrix 500 is expressed in the DIA format depicted in FIG. 5 is described. For example, the matrix 500 is thus expressed using matrix information 510.

The matrix information 510 is formed by offsets array 511 and a data matrix 512. In the offsets array 511, the offset value to identify any diagonal of the main diagonal and the sub-diagonals is set as an element. “The offset value=0” indicates the main diagonal. “The offset value=−x” indicates a sub-diagonal that is the x-th one from the side close to the main diagonal and that is present on the lower left side of the main diagonal. “The offset value=+x” indicates a sub-diagonal that is the x-th one from the side close to the main diagonal and that is present on the upper right side of the main diagonal.

The data matrix 512 has columns each corresponding to the diagonal indicated by an offset value. The i-th column of the data matrix 512 corresponds to the diagonal indicated by the offset value set as the i-th element of the offsets array 511. In the data matrix 512, each element on a diagonal indicated by the offset value of the main diagonal and the sub-diagonals is set as the element in the column that corresponds to the diagonal. The matrix information 510 may thereby make the non-zero elements on the part of the diagonals be identifiable such that the prefetch effectively works and the improvement of the processing speed may be easily facilitated.

An example where a matrix is expressed in the ELL format is described next with reference to FIG. 6 and FIG. 7.

FIG. 6 and FIG. 7 are explanatory diagrams each depicting an example where a matrix is expressed in the ELL format. For example, an example where a matrix 600 is expressed in the ELL format is described with reference to FIG. 6. The matrix 600 is, for example, same as the matrix 500. For example, the matrix 600 is expressed using matrix information 610.

The matrix information 610 is formed by a data matrix 611 and a col_index matrix 612. In the data matrix 611, a non-zero element in the i-th row of the matrix 600 is set as an element in the i-th row. When the number of the non-zero elements in the i-th row of the matrix 600 is greater than the number of the elements capable of being set in the i-th row of the data matrix 611, the i-th row of the data matrix 611 is padded by the value 0.

In the col_index matrix 612, the column index of a non-zero element in the i-th row of the matrix 600 is set as an element in the i-th row. The column index of the j-th non-zero element in a row is, for example, “j”. When the number of the non-zero elements in the i-th row of the matrix 600 is greater than the number of the elements capable of being set in the i-th row of the col_index matrix 612, the i-th row of the col_index matrix 612 is padded by a special value “*”. The special value * may be, for example, a value 0. The matrix information 610 may thereby cause the non-zero elements in a part of the rows to be identifiable. The description with reference to FIG. 7 is given next.

Another example, for example, where a matrix 700 is expressed in the ELL format is described with reference to FIG. 7. Differing from the matrix 600, the matrix 700 includes no non-zero element in its third row. For example, the matrix 700 may be expressed using matrix information 710 taking into consideration the rows each including no non-zero element.

The matrix information 710 is formed by row_ptr array 711, a data matrix 712, and a col_index matrix 713. In the row_ptr array 711, the row index of a row having a non-zero element present therein of the matrix 700 is set as an element. The row index of the i-th row is, for example, “i”. The row number is assigned from, for example, the number “0”.

In the data matrix 712, a non-zero element in the row of the row index indicated by the i-th element of the row_ptr array 711 is set as an element in the i-th row. When the number of the non-zero element in the row of the row index indicated by the i-th element of the row_ptr array 711 is greater than the number of the elements capable of being set in the i-th row of the data matrix 712, the i-th row of the data matrix 712 is padded by a value “0”.

In the col_index matrix 713, the column index of a non-zero element in the row of the row index indicated by the i-th element of the row_ptr array 711 is set as an element in the i-th row. When the number of the non-zero elements in the row of the row index indicated by the i-th element of the row_ptr array 711 is greater than the number of the elements capable of being set in the i-th row of the index matrix 713, the i-th row of the index matrix 713 is padded by a special value “*”. The special value * may be, for example, a value 0. The matrix information 710 may thereby make the non-zero elements in a part of the rows be identifiable. The matrix information 710 may make the rows each having no non-zero element present therein be identifiable.

An example where a matrix is expressed in the CSR format is described next with reference FIG. 8.

FIG. 8 is an explanatory diagram depicting an example where a matrix is expressed in the CSR format. An example, for example, where a matrix 800 is expressed in the CSR format is described with reference to FIG. 8. The matrix 800 is same as the matrix 500 and the matrix 600. For example, the matrix 800 is expressed using matrix information 810.

The matrix information 810 is formed by data array 811, a col_index matrix 812, and row_ptr array 813. In the data array 811, the non-zero elements in each of the rows of the matrix 800 are sequentially set as the elements. In the col_index matrix 812, the column index of the non-zero element indicated by the i-th element of the data array 811 is set as the i-th element.

In the row_ptr array 813, the element index of the element indicating the non-zero element at the head of each of the rows of the data array 811 is set as an element. The element index of the k-th element is, for example, “k”. The element number is assigned from, for example, the number “0”. The matrix information 810 may thereby make the non-zero elements in a part of the rows be identifiable.

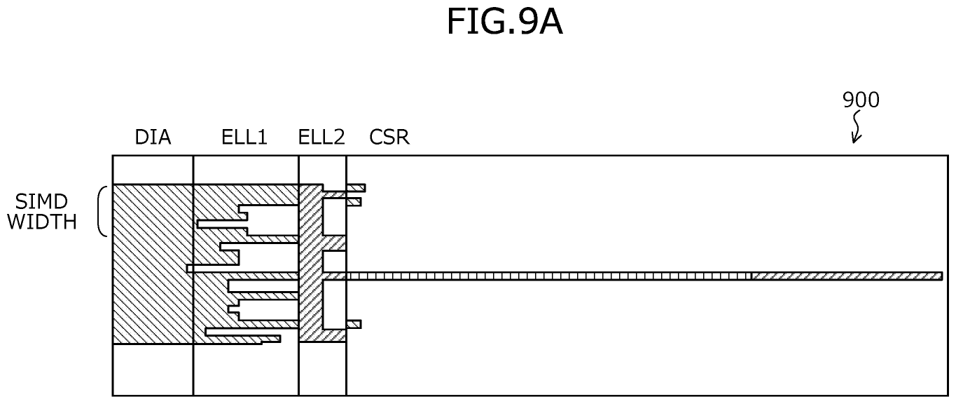

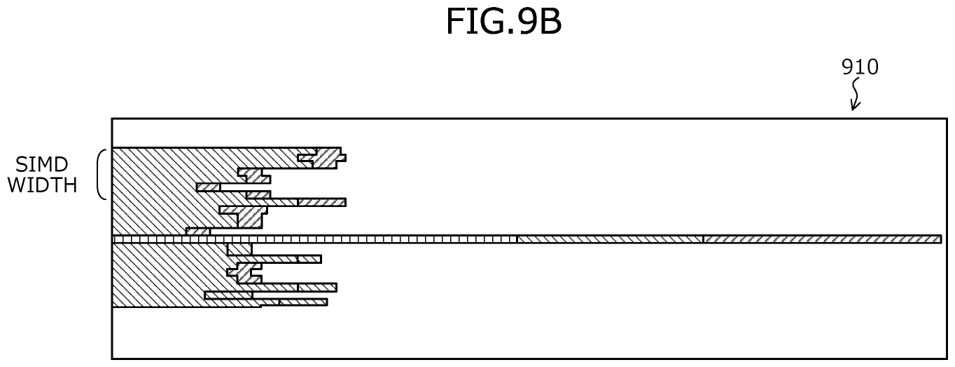

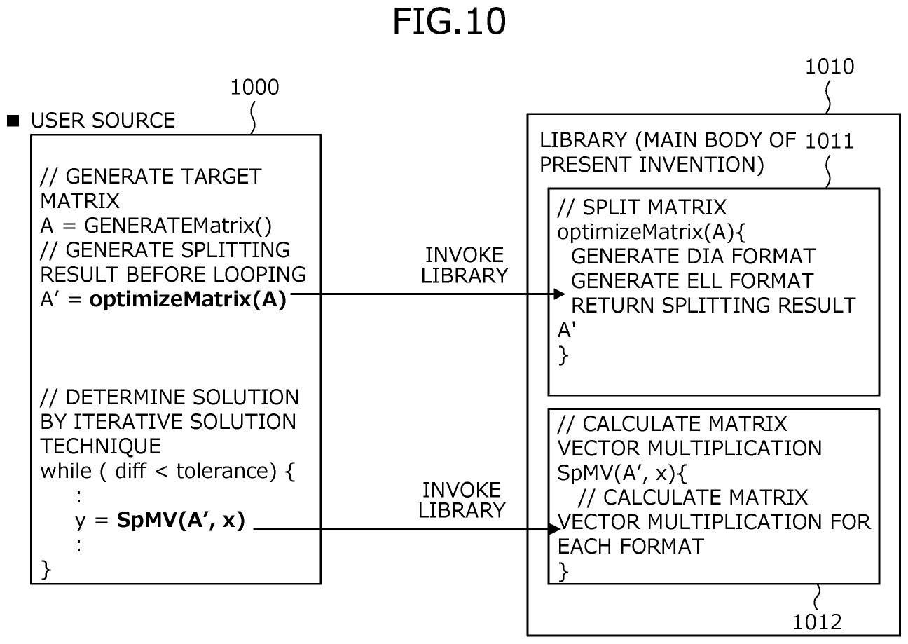

A flow of the operation of the information processing device 100 using the various formats of the DIA format, the ELL format, and the CSR format is described next with reference to FIGS. 9A, 9B, and 10.

FIGS. 9A, 9B, and 10 are explanatory diagrams depicting a flow of the operation of the information processing device 100. In FIGS. 9A, 9B, the information processing device 100 extracts the non-zero elements on a part of the diagonals from a sparse target matrix and generates matrix information in the DIA format that represents the extracted non-zero elements on the part of the diagonals. The information processing device 100 generates matrix information in the ELL format and matrix information in the CSR format that indicate the non-zero elements other than the extracted non-zero elements on the part of the diagonals.

A graph 900 depicts a portion of the distribution of the column indexes of the non-zero elements indicated by the matrix information in the DIA format, a portion of the distribution of the column indexes of the non-zero elements indicated by the matrix information in the ELL format, and a portion of the distribution of the column indexes of the non-zero elements indicated by the matrix information in the CSR format. A vertical line hatching portion indicates that the column indexes are relatively small. A diagonally right-up line hatching portion indicates that the column indexes are relatively great. A diagonally right-down line hatching portion indicates that the column indexes are intermediate.

As depicted in the graph 900, when the information processing device 100 executes calculation relating to the non-zero elements indicated by the matrix information in the DIA format of the overall calculation for the matrix vector multiplication, the information processing device 100 may consecutively execute the calculation relating to the non-zero elements whose column indexes are intermediate and relatively close to each other. The information processing device 100 may therefore effectively use the SIMD, may effectively use the prefetch, may make each of the non-zero elements be efficiently accessible, and may efficiently execute the calculation.

When the information processing device 100 executes the calculation relating to the non-zero elements indicated by the matrix information in the ELL format of the overall calculation for the matrix vector multiplication, the information processing device 100 may execute the calculation relating to the non-zero elements whose column indexes are relatively close to each other. The information processing device 100 may therefore efficiently execute the calculation. The information processing device 100 may execute the calculation relating to the non-zero elements indicated by the matrix information in the CSR format of the overall calculation for the matrix vector multiplication. The information processing device 100 may therefore make the overall calculation for the matrix vector multiplication be fully executable.

In contrast, in the conventional approaches, a case may be considered where the target matrix is expressed using only the matrix information in the CSR format. A graph 910 depicts a portion of the distribution of the column indexes of the non-zero elements indicated by the matrix information in the CSR format in a case where the target matrix is expressed using only the matrix information in the CSR format. In this case, it may be considered that, as depicted in the graph 910, the pieces of calculation relating to the non-zero elements whose column indexes are relatively significantly different from each other may be executed being mixed with each other, access of the memory therefore becomes random, the prefetch consequently tends to avoid its effective work, and it is consequently difficult to efficiently execute the calculation for the matrix vector multiplication. Description with reference to FIG. 10 is given next to describe an example where the operation of the information processing device 100 is realized.

As depicted in FIG. 10, the information processing device 100 may be designed to have a library 1010 that realizes the above various types of operations for a target matrix designated by the user and to thereby execute the overall calculation for a matrix vector multiplication. The library 1010 includes a program 1011 and a program 1012.

The program 1011 is, for example, a program to generate the matrix information in the DIA format, the matrix information in the ELL format, and the matrix information in the CSR format. The program 1011 includes, for example, a function “optimizeMatrix(A){ }” that divides a target matrix A and that generates the matrix information in the DIA format, the matrix information in the ELL format, and the matrix information in the CSR format. The function optimizeMatrix(A){ } returns a splitting result A′ that includes the matrix information in the DIA format, the matrix information in the ELL format, and the matrix information in the CSR format.

The program 1012 is, for example, a program to execute the overall calculation for the matrix vector multiplication. The program 1012 includes, for example, a function “SpMV(A′,x){ }” that executes the overall calculation for the matrix vector multiplication. The function SpMV(A′,x){ } returns the result obtained by calculating the matrix vector multiplication based on the splitting result A′.

For example, the information processing device 100 obtains a user source 1000, refers to the library 1010 based on the user source 1000, and executes the overall calculation for the matrix vector multiplication. For example, the information processing device 100 receives an input of the user source 1000, based on an operational input by the user. For example, the information processing device 100 may obtain the user source 1000 by receiving the user source 1000 from another computer. The other computer is, for example, the client device 202.

For example, the user source 1000 invokes a function “generateMatrix( )” that generates the target matrix A and prescribes generation of the target matrix A. For example, the user source 1000 invokes the function optimizeMatrix(A) and prescribes generation of the splitting result A′.

For example, the user source 1000 invokes a function SpMV(A′,x) in a loop process of while(diff<tolerance), prescribes that the calculation for the matrix vector multiplication is executed, and prescribes that the linear equation is solved using an iterative solution technique. “diff” is an error occurring between, for example, a vector indicating the result of the calculation for the matrix vector multiplication and a vector of the correct solution. “tolerance” is a threshold value for “diff” and is a criterion for determining the convergence of the iterative solution technique. The information processing device 100 may thereby efficiently execute the calculation for the matrix vector multiplication and may realize the operation of solving the linear equation.

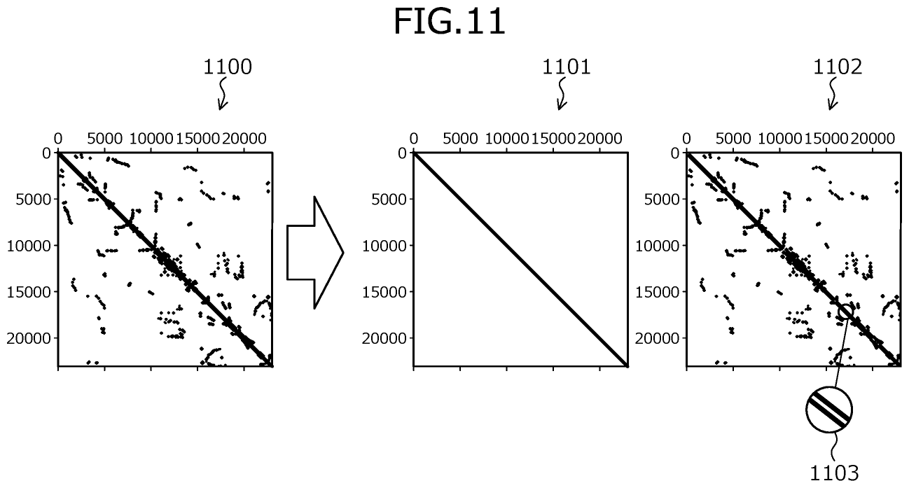

An example of the operation of the information processing device 100 is described next with reference to FIG. 11 to FIG. 22. An example where the information processing device 100 generates a matrix in the DIA format is first described with reference to FIG. 11 to FIG. 13.

FIGS. 11, 12, and 13 are explanatory diagrams depicting an example where a matrix in the DIA format is generated. In FIG. 11, it is assumed that the information processing device 100 obtains a target matrix 1100. In the example in FIG. 11, a black portion of the matrix 1100 indicates the position at which a non-zero element is present. The information processing device 100 splits the matrix 1100 into an element matrix 1101 obtained by extracting the elements on a part of the diagonals, and an element matrix 1102 obtained by extracting the rest of the elements.

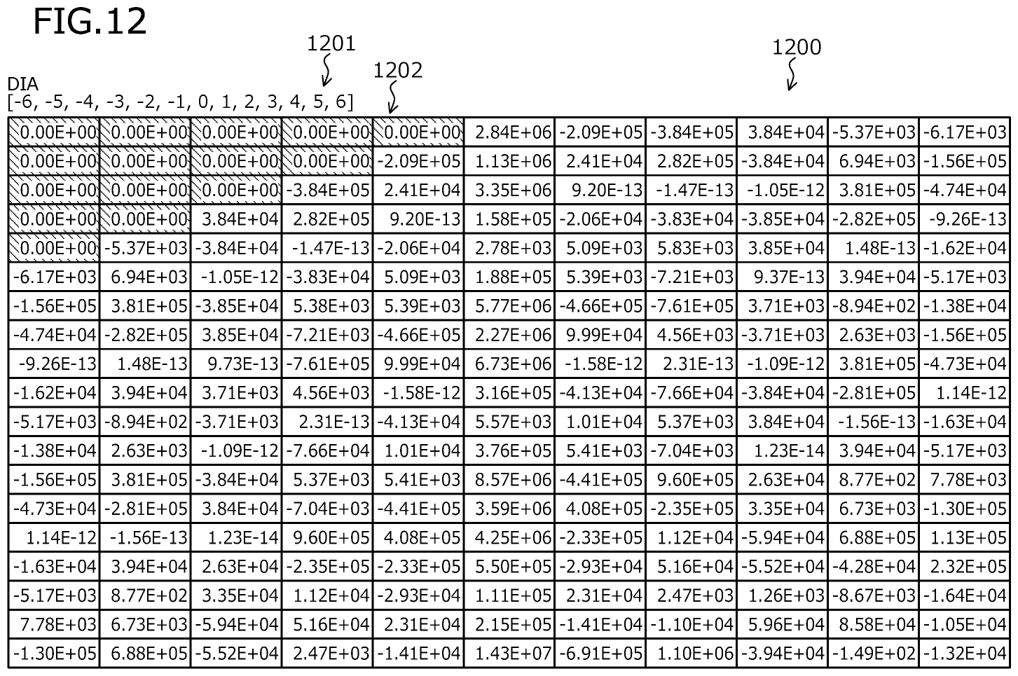

For example, the element matrix 1101 is generated by extracting each of the elements on the part of the diagonals including the main diagonal and the sub-diagonals that are relatively close to the main diagonal, from the matrix 1100. As depicted in an enlarged diagram 1103, for example, the element matrix 1102 is generated by extracting the elements other than the elements on the part of the diagonals from the matrix 1100. Description with reference to FIG. 12 is given next and a specific example where the information processing device 100 extracts each of the elements on the part of the diagonals and generates a matrix in the DIA format is described.

In FIG. 12, the information processing device 100 obtains a range of the diagonals that is set in advance. A case may be considered where it is assumed, for example, that the main diagonal is denoted by the number 0, the diagonals in the lower-left direction of the main diagonal are denoted by the number −1, the number −2, . . . , the number −N, from the side close to the main diagonal, and the diagonals in the upper-right direction of the main diagonal are denoted by the number +1, the number +2, . . . , the number +N, from the side close to the main diagonal. In this case, the range of the diagonal is, for example, a range from the −n-th diagonal to the +n-th diagonal.

For example, the information processing device 100 extracts the non-zero elements on each of the diagonals in the range from the −u-th diagonal to the +u-th diagonal and generates a matrix 1200 in the DIA format. The matrix 1200 includes an array 1201 and a matrix 1202. The information processing device 100 may thereby gather a part of the non-zero elements of the matrix 1100 such that the SIMD may be effectively used and the prefetch may be effectively used. The information processing device 100 uses the DIA format and may therefore make each of the non-zero elements be efficiently accessible and may make the calculation be efficiently executable.

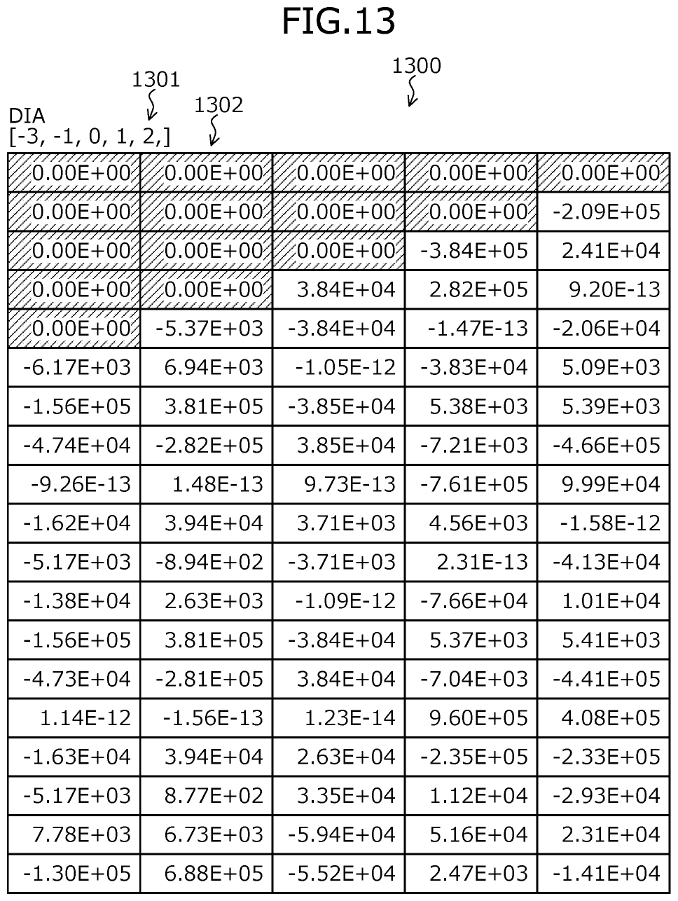

As depicted in FIG. 13, the information processing device 100 may select the diagonals to be expressed in the DIA format in the range of the diagonal that is set in advance. For example, the information processing device 100 calculates the number of the non-zero elements on each of the diagonals in the range from the −u-th diagonal to the +u-th diagonal. For example, the information processing device 100 selects the diagonals each having the non-zero elements that are at least equal to a threshold value in the range from the −u-th diagonal to the +u-th diagonal. The threshold value is, for example, set in advance by the user. The threshold value is, for example, the number of rows of the matrix 1100×0.75.

In the example in FIG. 13, it is assumed that the information processing device 100 selects the number −3 diagonal, the number −1 diagonal, the number 0 diagonal, the number 1 diagonal, and the number 2 diagonal. For example, the information processing device 100 extracts the non-zero elements on the selected diagonals and generates a matrix 1300 in the DIA format. The matrix 1300 includes an array 1301 and a matrix 1302. The information processing device 100 may thereby gather a part of the non-zero elements of the matrix 1100 such that the SIMD may be effectively used and the prefetch may be effectively used. The information processing device 100 may complete the calculation without gathering the elements on the diagonals for which it is difficult to effectively use the prefetch. The information processing device 100 uses the DIA format and may therefore make each of the non-zero elements be efficiently accessible and may make the calculation be efficiently executable.

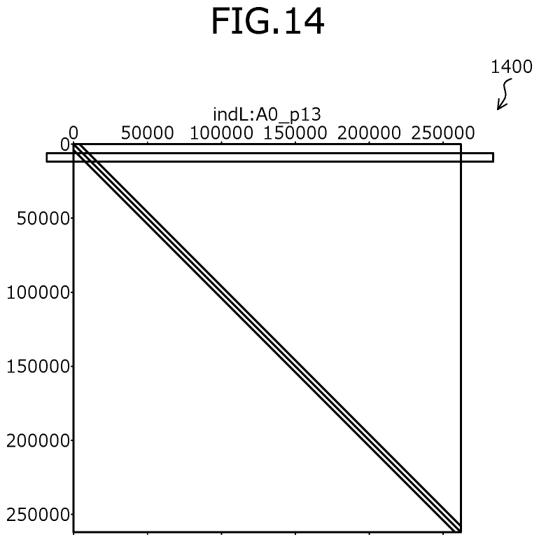

Another example where the information processing device 100 generates a matrix in the DIA format is described next with reference to FIG. 14 to FIG. 17.

FIGS. 14, 15, 16, and 17 are explanatory diagrams depicting another example where a matrix in the DIA format is generated. In FIG. 14, it is assumed that the information processing device 100 obtains a target matrix 1400. The target matrix 1400 exhibits, for example, the nature of a three-dimensional lattice. The matrix 1400 may therefore include plural groups of the diagonals each having relatively many non-zero elements. For example, it may be considered that the matrix 1400 includes the diagonals each having relatively many non-zero elements in a vicinity of the −N×N-th diagonal, in a vicinity of the 0-th diagonal, and in a vicinity of the +N×N-th diagonal. N is 16.

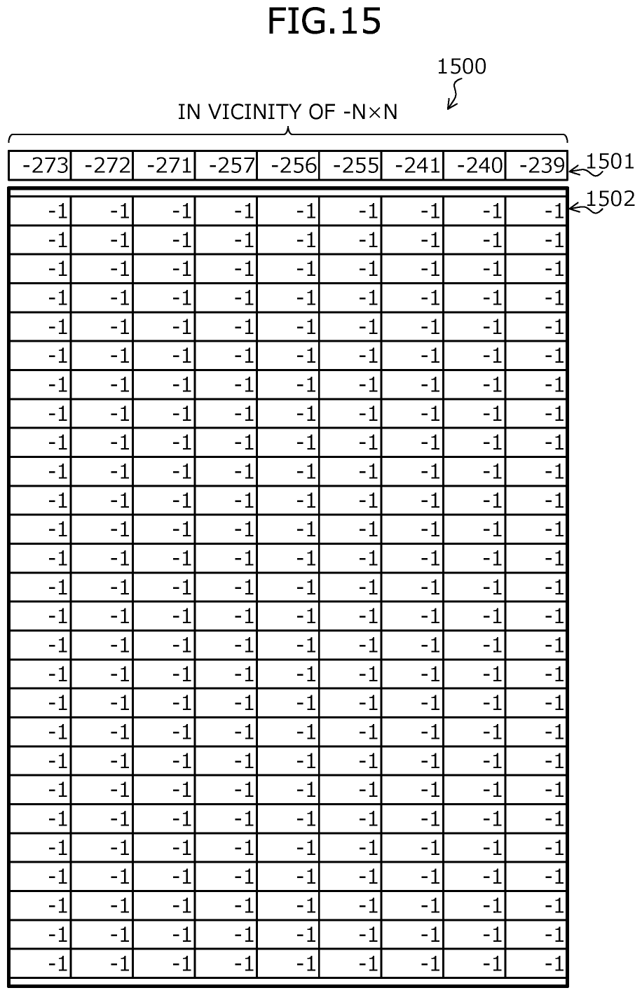

As depicted in FIG. 15, the information processing device 100 therefore extracts the non-zero elements on the diagonals in the vicinity of the −N×N-th diagonal and generates a matrix 1500 in the DIA format. The matrix 1500 includes an array 1501 and a matrix 1502. For example, the information processing device 100 may select the diagonals each having the non-zero elements that are at least equal to a threshold value in the range from the −(N×N+20)-th diagonal to the −(N×N−20)-th diagonal. For example, the information processing device 100 extracts the non-zero elements on the selected diagonals and generates the matrix 1500 in the DIA format.

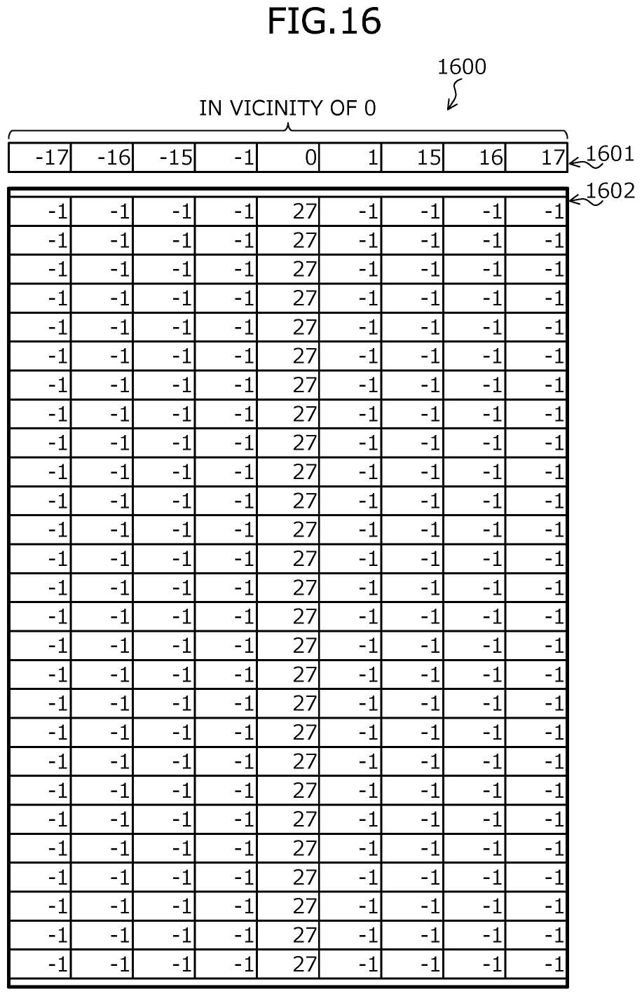

As depicted in FIG. 16, the information processing device 100 extracts the non-zero elements on the diagonals in a vicinity of the 0-th diagonal and generates a matrix 1600 in the DIA format. The matrix 1600 includes array 1601 and a matrix 1602. For example, the information processing device 100 may select the diagonals each having the non-zero elements that are equal to or more than the threshold value in the range from the +20-th diagonal to the −20-th diagonal. For example, the information processing device 100 extracts the non-zero elements on the selected diagonals and generates the matrix 1600 in the DIA format.

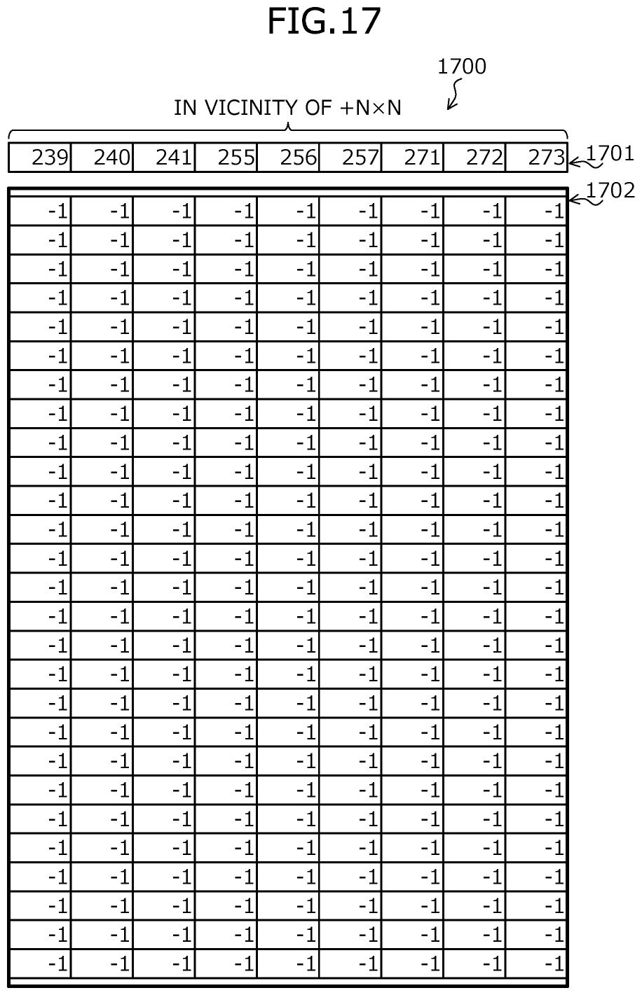

As depicted in FIG. 17, the information processing device 100 extracts the non-zero elements on the diagonals in the vicinity of the +N×N-th diagonal and generates a matrix 1700. The matrix 1700 includes an array 1701 and a matrix 1702. For example, the information processing device 100 may select the diagonals each having the non-zero elements that are at least equal to a threshold value in the range from the +(N×N+20)-th diagonal to the +(N×N+20)-th diagonal. For example, the information processing device 100 extracts the non-zero elements on the selected diagonals and generates the matrix 1700 in the DIA format.

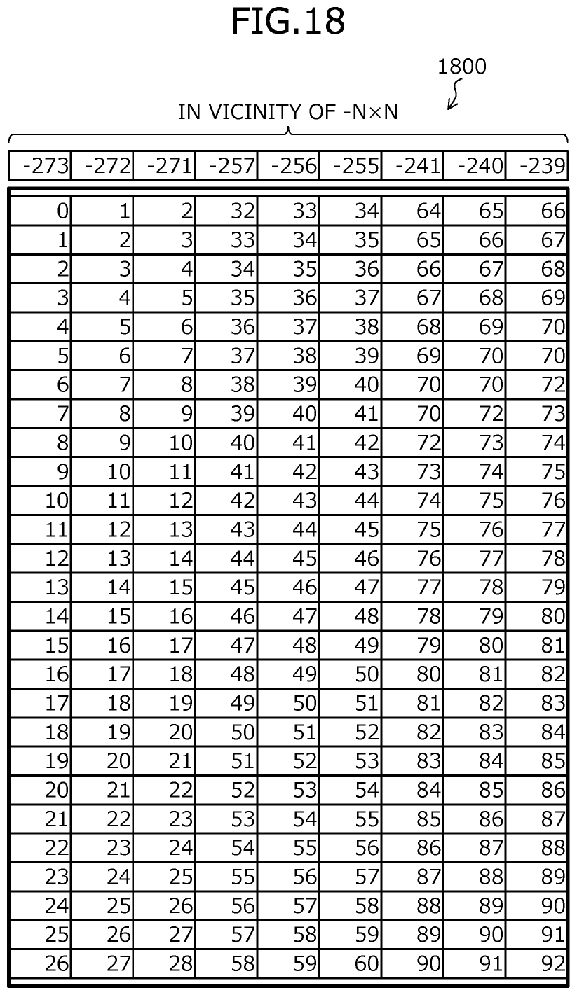

An example of an access pattern for the information processing device 100 to access the elements of the vector x corresponding to the matrix 1500 in the DIA format, the matrix 1600 in the DIA format, and the matrix 1700 in the DIA format is described next with reference to FIG. 18 to FIG. 20.

FIGS. 18, 19, and 20 are explanatory diagrams depicting an example of the access pattern. For example, a matrix 1800 in FIG. 18 indicates the column indexes of the elements of the vector x, that is, the column indexes that the information processing device 100 accesses corresponding to each of the elements represented by the matrix 1500 in the DIA format, for the calculation for the matrix vector multiplication. The value set at the element in the i-th row and the j-th column of the matrix 1800 indicates the column index of the element of the vector x, that is, the column index that is to be accessed corresponding to the element set at the element in the i-th row and the j-th column of the matrix 1500.

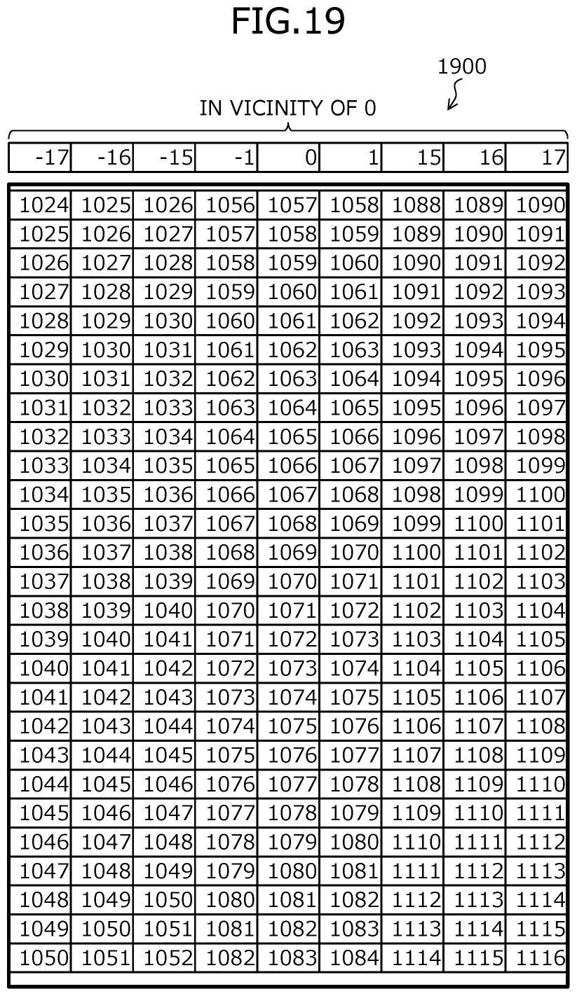

As described above, the information processing device 100 tends to relatively regularly access consecutive elements that are included in the vector x, when the information processing device 100 executes the calculation corresponding to the matrix 1500 of the calculation for the matrix vector multiplication. The information processing device 100 may therefore make the SIMD be effectively usable and may make the prefetch effectively be usable. Next, FIG. 19 is described.

For example, a matrix 1900 in FIG. 19 indicates the column indexes of the elements of the vector x, that is, the column indexes that the information processing device 100 accesses corresponding to each of the elements represented by the matrix 1600 in the DIA format, for the calculation for the matrix vector multiplication. The value set at the element in the i-th row and the j-th column of the matrix 1900 indicates the column index of the element of the vector x, the column index that is to be accessed corresponding to the element set at the element in the i-th row and the j-th column of the matrix 1600.

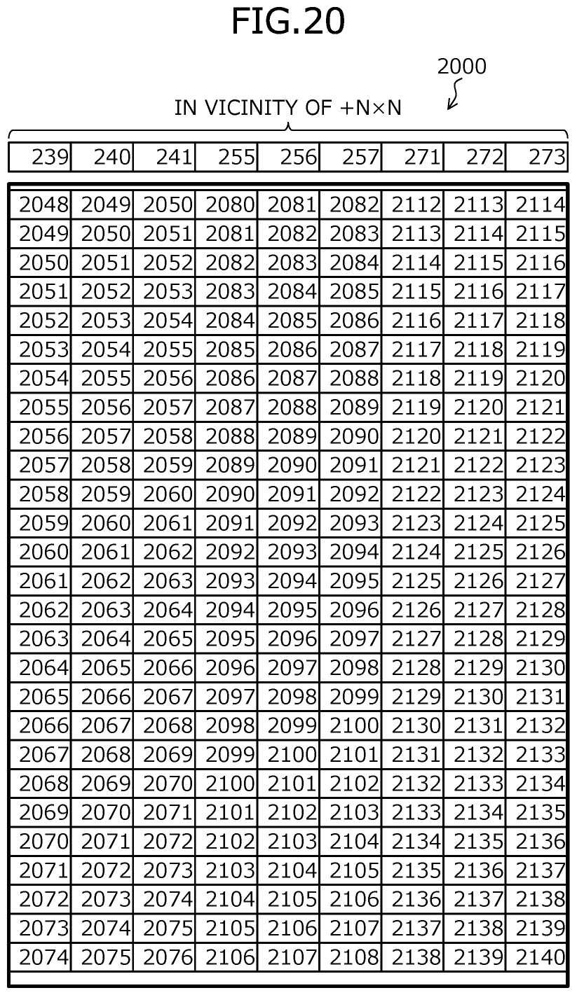

As described above, the information processing device 100 tends to relatively regularly access consecutive elements that are included in the vector x, when the information processing device 100 executes the calculation corresponding to the matrix 1600 of the calculation for the matrix vector multiplication. The information processing device 100 may therefore make the SIMD be effectively usable and may make the prefetch effectively be usable. Next, FIG. 20 is described.

For example, a matrix 2000 in FIG. 20 indicates the column indexes of the elements of the vector x, that is, the column indexes that the information processing device 100 accesses corresponding to each of the elements represented by the matrix 1700 in the DIA format, for the calculation for the matrix vector multiplication. The value set at the element in the i-th row and the j-th column of the matrix 2000 indicates the column index of the element of the vector x, that is, the column index that is to be accessed corresponding to the element set at the element in the i-th row and the j-th column of the matrix 1700.

As described above, the information processing device 100 tends to relatively regularly access consecutive elements that are included in the vector x, when the information processing device 100 executes the calculation corresponding to the matrix 1700 of the calculation for the matrix vector multiplication. The information processing device 100 may therefore make the SIMD be effectively usable and may make the prefetch effectively be usable.

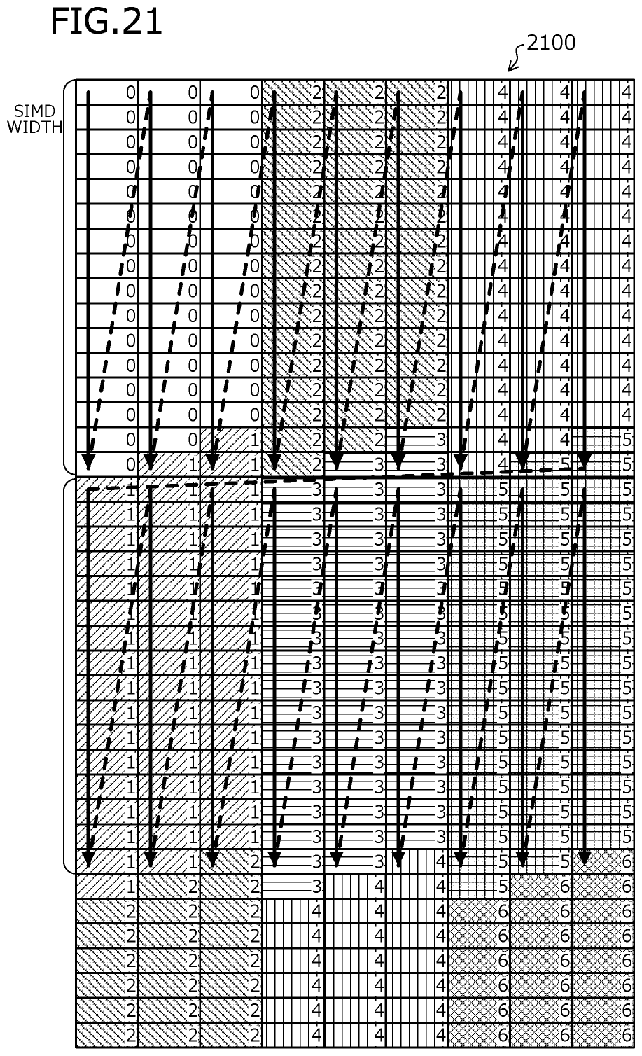

An example of the prefetch in a case where the information processing device 100 executes the calculation for the matrix vector multiplication is described next with reference to FIG. 21.

FIG. 21 is an explanatory diagram depicting an example of the prefetch. With reference to FIG. 21, a case is described where the information processing device 100 executes a portion of the calculation for the matrix vector multiplication corresponding to a matrix in the DIA format. A matrix 2100 represents access indexes in units of cache line, related to the vector x and accessed in a case where a portion of the calculation for the matrix vector multiplication is executed corresponding to the element represented by the matrix in the DIA format. The access index is, for example, a value obtained by dividing a column index×8 bytes by the cache line size. The cache line size is, for example, 64 bytes. Eight (8) bytes corresponds to a double-precision floating point. The value described in the i-th row in the j-th column of the matrix 2100 represents an access index in the cache line unit related to the vector x and accessed in the case where a portion of the calculation for the matrix vector multiplication is executed corresponding to the element set at the element in the i-th row in the j-th column of the data matrix in the DIA format.

In a case where the information processing device 100 executes a portion of the calculation for the matrix vector multiplication corresponding to a matrix in the DIA format, as indicated by a solid arrow in FIG. 21, the information processing device 100 executes the portion of the calculation for the matrix vector multiplication for the SIMD width, based on the element of the vector x corresponding to the access index. As indicated by any of the solid arrows in FIG. 21, the information processing device 100 executes the portion of the calculation for the matrix vector multiplication for the SIMD width and, thereafter, as indicated by another solid arrow positioned ahead of a dotted arrow, newly executes a portion of the calculation for the matrix vector multiplication for the SIMD width.

In this case, for example, the information processing device 100 reads 16 elements for 64 bytes of the vector x, stores the read 16 elements in the cache as data of the 0-th access index, and executes the portion of the calculation for the matrix vector multiplication based on the data of the 0-th access index. The information processing device 100, taking, for example, the regularity of the accesses into consideration, reads the 16 elements for 64 bytes of the vector x following thereafter, and prefetches the read 16 elements in advance in the cache as the data of the first access index.

Next, the information processing device 100 again uses the data of the 0-th access index and the data of the first access index in the cache and thereby executes the portion of the calculation for the matrix vector multiplication. For example, the information processing device 100, taking, for example, the regularity of the accesses into consideration, reads the 16 elements for 64 bytes of the vector x following further thereafter, and prefetches the read 16 elements in advance in the cache as the data of the second access index. The information processing device 100 thereafter similarly executes the calculation for the matrix vector multiplication consecutively for a portion thereof at a time. In this manner, the information processing device 100 may easily facilitate effective use of the prefetch by using the matrix in the DIA format.

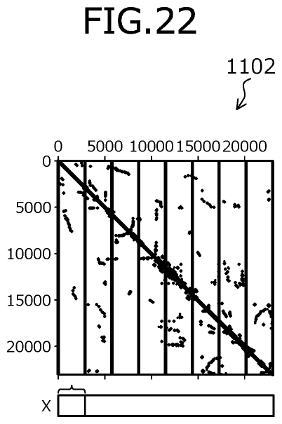

Next, with reference to FIG. 22, an example is described where the information processing device 100 generates a matrix in the ELL format based on the elements other than the elements present on the part of the diagonals.

FIG. 22 is an explanatory diagram depicting an example where a matrix in the ELL format is generated. In FIG. 22, the information processing device 100 generates a matrix in the ELL format based on, for example, the element matrix 1102. For example, the information processing device 100 splits the element matrix 1102 in the column direction and identifies plural submatrices. For example, the information processing device 100 generates a matrix in the ELL format for each of the identified submatrices.

The information processing device 100 may thereby limit the range of the vector x accessed corresponding to the matrix in the ELL format for each of the matrices in the ELL format. The information processing device 100 may therefore easily facilitate reuse of the cache and may facilitate improvement of the efficiency of the calculation for the matrix vector multiplication.

Here, for example, the information processing device 100 may express the rows each having the non-zero elements that are fewer than a threshold value, using a matrix in the ELL format. For example, the information processing device 100 expresses the rows each having the non-zero elements that are fewer than the threshold value, using a matrix in the CSR format. The information processing device 100 may thereby facilitate improvement of the efficiency of the calculation for the matrix vector multiplication.

Here, for example, as depicted in FIG. 7, when a row having no non-zero element present therein is present, the information processing device 100 may generate a matrix in the ELL format taking this row into consideration. For example, the information processing device 100 expresses the row having no non-zero element present therein, using a matrix in the CSR format. The information processing device 100 may thereby facilitate improvement of the efficiency of the calculation for the matrix vector multiplication.

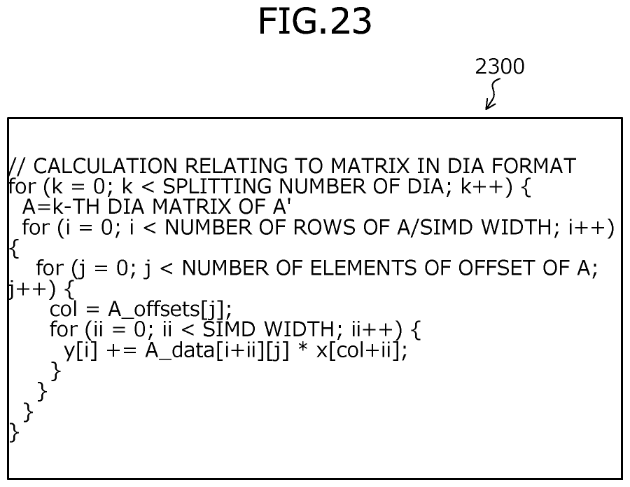

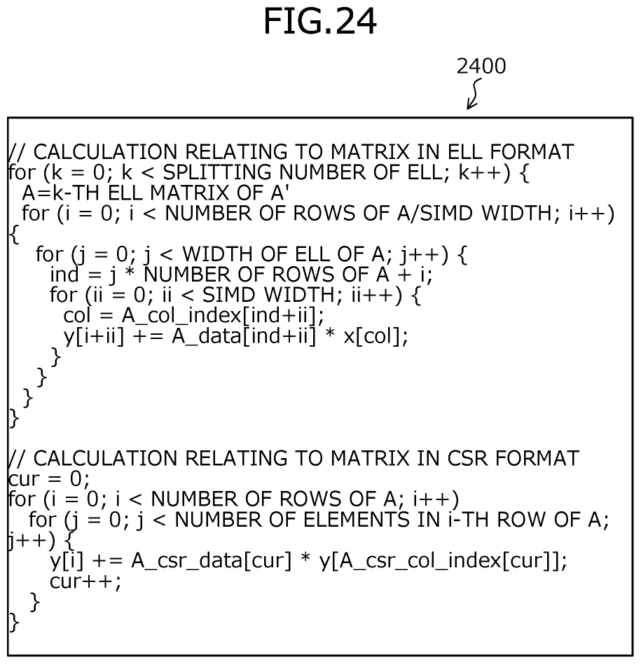

A specific example of the calculation for a matrix vector multiplication executed by the information processing device 100 is described next with reference to FIG. 23 and FIG. 24.

FIG. 23 and FIG. 24 are explanatory diagrams depicting a specific example of the calculation for the matrix vector multiplication. In FIG. 23 and FIG. 24, the information processing device 100 executes the calculation for the matrix vector multiplication of the target matrix A and the vector x based on a matrix in the DIA format, a matrix in the ELL format, and a matrix in the CSR format. It is assumed that the matrix in the DIA format is generated for, for example, each of the groups of a predetermined splitting number. It is assumed that the matrix in the ELL format is generated for each of the submatrices of a predetermined splitting number.

The information processing device 100 initializes a vector y that stores therein, for example, the result of the execution of the calculation for the matrix vector multiplication. The initialization is, for example, to set an element to be 0. For example, the information processing device 100 consecutively adds the product of the elements of the matrix A and the elements of the vector x to the elements of the vector y, based on the matrix in the DIA format, the matrix in the ELL format, and the matrix in the CSR format. Hereinafter in the description, the matrix in the DIA format, the matrix in the ELL format, and the matrix in the CSR format collectively may be denoted by “A′”. Next, description with reference to FIG. 23 is given.

In FIG. 23, for example, as denoted by a reference numeral 2300, the information processing device 100 sets A to be A=the k-th matrix in the DIA format of A′, and repeatedly calculates y[i]+=A_data[i+ii][j]*x[col+ii]. “y[a]” is the a-th element of the vector y. “A_data[b][c]” is the element in the b-th row in the c-th column of the data matrix of the matrix in the DIA format. “x[d]” is the d-th element of the vector x. “A_offsets[e]” is the e-th element of the offsets array in the DIA format. Next, description with reference to FIG. 24 is given.

In FIG. 24, for example, as denoted by a reference numeral 2400, the information processing device 100 sets A to be A=the k-th matrix in the ELL format of A′, and repeatedly calculates y[i+ii]+=A_data[ind+ii]*x[col]. “A_data[f]” is the f-th non-zero element sequentially counted from above in the row direction in the data matrix of the matrix in the ELL format. “A_col_index[g] is the g-th non-zero element sequentially counted from above in the row direction in the col_index matrix of the matrix in the ELL format.

For example, as denoted by the reference numeral 2400, the information processing device 100 repeatedly calculates y[i]+=A_csr_data[cur]*y[A_csr_col_index[cur]];. “A_cst_data[h]” is the h-th element of the data matrix of the matrix in the CSR format. The information processing device 100 may thereby execute the overall calculation for the matrix vector multiplication.

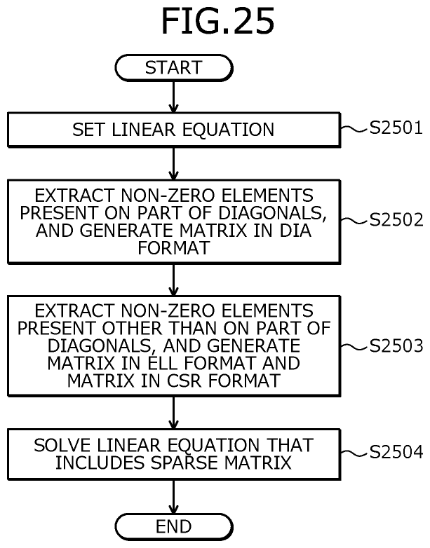

An example of the overall process procedure executed by the information processing device 100 is described next with reference to FIG. 25. The overall process is realized by, for example, the CPU 301, the storage areas such as the memory 302 and the recording medium 305, and the network I/F 303 that are depicted in FIG. 3.

FIG. 25 is a flowchart depicting an example of the overall process procedure. In FIG. 25, the information processing device 100 sets a linear equation that includes a sparse matrix (step S2501).

The information processing device 100 next analyzes the sparse matrix, extracts the non-zero elements present on a part of the diagonals, and generates a matrix in the DIA format (step S2502). The information processing device 100 analyzes the sparse matrix, extracts the non-zero elements present other than on the part of the diagonals, and generates a matrix in the ELL format and a matrix in the CSR format (step S2503).

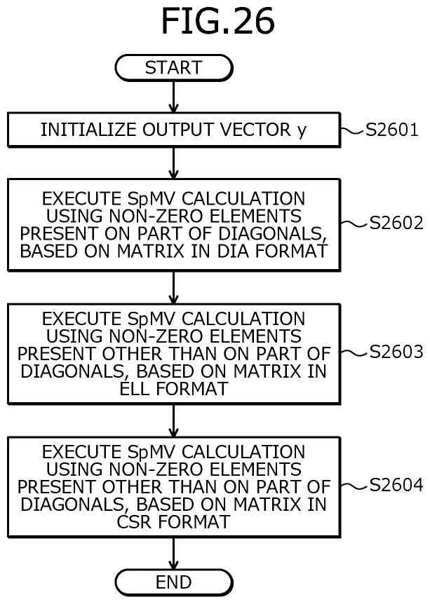

The information processing device 100 next executes a calculation process described later with reference to FIG. 26 and solves the linear equation that includes the sparse matrix, based on the matrix in the DIA format, the matrix in the ELL format, and the matrix in the CSR format (step S2504). The information processing device 100 ends the overall process.

An example of a calculation process procedure executed by the information processing device 100 is described with reference to FIG. 26. The calculation process is realized by, for example, the CPU 301, the storage areas such as the memory 302 and the recording medium 305, and the network I/F 303 that are depicted in FIG. 3.

FIG. 26 is a flowchart depicting an example of a calculation process procedure. In FIG. 26, the information processing device 100 initializes an output vector y (step S2601). The information processing device 100 next executes SpMV calculation using the non-zero elements present on the part of the diagonals, based on the matrix in the DIA format and thereby updates the output vector y (step S2602).

The information processing device 100 next executes the SpMV calculation using the non-zero elements present other than on the part of the diagonals, based on the matrix in the ELL format and thereby updates the output vector y (step S2603). The information processing device 100 executes the SpMV calculation using the non-zero elements present other than on the part of the diagonals, based on the matrix in the CSR format and thereby updates the output vector y (step S2604). The information processing device 100 thereafter sets the output vector y as the solution of the linear equation and ends the calculation process.

The information processing device 100 may interchange the order of the processes at some of the steps of each of the flowcharts in FIG. 25 and FIG. 26 to execute the processes. For example, the order of the processes at steps S2602 and S2603 is interchanged. The information processing device 100 may skip the processes at some of the steps of each of the flowcharts in FIG. 25 and FIG. 26. For example, when the matrix in the CSR format is not generated, the process at step S2603 may be skipped.

As described above, according to the information processing device 100, the matrix for which the calculation for the matrix vector multiplication is to be executed may be obtained. According to the information processing device 100, a first matrix may be generated that is in a first format and represents an element group including the non-zero elements on a part of the diagonals, among the main diagonal and the sub-diagonals parallel to the main diagonal in the obtained matrix. According to the information processing device 100, a second matrix may be generated that is in a second format different from the first format and that represents an element group including the non-zero elements in at least a part of the rows or the columns that form the obtained matrix, other than the elements on the part of the diagonals. The information processing device 100 may thereby select the non-zero elements such that the prefetch tends to be effectively used and the information processing device 100 may facilitate more efficient calculation for the matrix vector multiplication.

According to the information processing device 100, the Diagonal format may be employed as the first format. According to the information processing device 100, the ELLpack format may be employed as the second format. The information processing device 100 may thereby set a proper format for each of the first format and the second format such that more efficient calculation for the matrix vector multiplication may be easily facilitated.

According to the information processing device 100, the first matrix may be generated that is in the first format and that represents an element group including the non-zero elements on a part of the diagonals, among the main diagonal and the sub-diagonals that are parallel to the main diagonal and that are relatively close to the main diagonal in the obtained matrix. The information processing device 100 may thereby generate the first matrix for the part of the diagonals on which are the non-zero elements for which it is determined that more efficient calculation for the matrix vector multiplication may be easily facilitated, and the information processing device 100 may easily facilitate more efficient calculation for the matrix vector multiplication.

According to the information processing device 100, the first matrix may be generated, that is in the first format and that represents an element group including the non-zero elements on the part of the diagonals whose numbers of the non-zero elements are each fewer than a second number, among the main diagonal and the sub-diagonals parallel to the main diagonal in the obtained matrix. The information processing device 100 may thereby select the part of the diagonals on which are the non-zero elements for which it is determined that more efficient calculation for the matrix vector multiplication may be easily facilitated, and the information processing device 100 may generate the first matrix for the selected part of diagonals. The information processing device 100 may facilitate more efficient calculation for the matrix vector multiplication.

According to the information processing device 100, for each of the groups that classify the diagonals, the first matrix may be generated, that is in the first format and that represents an element group including the non-zero elements on the diagonals classified in the group. The information processing device 100 may thereby generate the first matrix for the diagonals in each of the groups and on which are the non-zero elements for which it is determined that more efficient calculation for the matrix vector multiplication may be easily facilitated and thus, the information processing device 100 may facilitate more efficient calculation for the matrix vector multiplication.

According to the information processing device 100, plural submatrices obtained by splitting the obtained matrix in the column direction may be identified. According to the information processing device 100, a second matrix may be generated, that is in a second format and that represents an element group including the non-zero elements on at least a part of the rows that form the submatrix for each of the submatrices, other than the elements on the part of the diagonals. The information processing device 100 may thereby facilitate more efficient calculation for the matrix vector multiplication.

According to the information processing device 100, other than the elements on the part of the diagonals, a part of the rows or the columns may be identified, that form the obtained matrix and whose numbers of the non-zero elements are each at least equal to a third number. According to the information processing device 100, other than the elements on the part of the diagonals, a third matrix in a Compressed Sparse Row format may be generated, that represents an element group including the non-zero elements in a row or a column at an identified position. According to the information processing device 100, a second matrix in a ELLpack format may be generated, that represents an element group including the non-zero elements in the rest of the rows or the columns that are not identified, other than the elements on the part of the diagonals. The information processing device 100 may thereby facilitate more efficient calculation for the matrix vector multiplication.

According to the information processing device 100, a second matrix in a second format may be generated such that the rows or the columns forming the second matrix do not include the rows or the columns that represent the elements in the rows or the columns each having no non-zero element present therein, that form the obtained matrix. The information processing device 100 may thereby facilitate more efficient calculation for the matrix vector multiplication.

According to the information processing device 100, a second matrix in a second format may be generated that represents an element group including the non-zero elements in all the rows or all the columns that form the obtained matrix. The information processing device 100 may thereby make the overall calculation for the matrix vector multiplication be executable.

According to the information processing device 100, the calculation for the matrix vector multiplication for a target matrix and a predetermined vector may be executed based on the first matrix and the second matrix that are generated using a function of prefetching a portion of the predetermined vector. The information processing device 100 may thereby make the result of executing the calculation for the matrix vector multiplication be usable.

According to the information processing device 100, a matrix having sparseness may be obtained as a target matrix. The information processing device 100 may thereby operate in the state where more efficient calculation for a matrix vector multiplication may be easily facilitated.

The information processing method described in the present embodiment may be implemented by executing a prepared program on a computer such as a personal computer and a workstation. The program is stored on a non-transitory, computer-readable recording medium such as a hard disk, a flexible disk, a compact disc read-only memory (CD-ROM), a magnetic disk (MO), and a digital versatile disc (DVD), read out from the computer-readable medium, and executed by the computer. The program may be distributed through a network such as the Internet.

According to one aspect, more efficient calculation for a matrix vector multiplication may be facilitated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing therein an information processing program executable by a computer, the information processing program comprising:
an instruction for obtaining a matrix to be subject to a calculation for a matrix vector multiplication;
an instruction for generating a first matrix in a first format, the first matrix representing a first element group that includes non-zero elements among elements on a part of diagonals, among a main diagonal and sub-diagonals parallel to the main diagonal in the obtained matrix; and
an instruction for generating a second matrix in a second format different from the first format, the second matrix representing a second element group that includes the non-zero elements, among the elements in at least a part of rows or columns that form the obtained matrix, other than the elements on the part of the diagonals.

2. The recording medium according to claim 1, wherein
the first format is a Diagonal format, and
the second format is an ELLpack format.

3. The recording medium according to claim 1, wherein
the instruction for generating the first matrix includes generating the first matrix representing the first element group that includes the non-zero elements among the elements on the part of diagonals among the main diagonal and a first number of the sub-diagonals that are parallel to the main diagonal and that are relatively close to the main diagonal in the obtained matrix.

4. The recording medium according to claim 1, wherein
the instruction for generating the first matrix includes generating the first matrix representing the first element group that includes the non-zero elements that are among the elements on the part of diagonals whose numbers of the non-zero elements are each fewer than a second number, among the main diagonal and the sub-diagonals parallel to the main diagonal in the obtained matrix.

5. The recording medium according to claim 1, wherein
the part of diagonals includes a plurality of diagonals that are classified into different groups, and
the instruction for generating the first matrix includes generating the first matrix representing, for each of the groups, the first element group that includes the non-zero elements among the elements on the diagonals classified into the group.

6. The recording medium according to claim 1, wherein
the instruction for generating the second matrix includes splitting the obtained matrix in a column direction thereby obtaining a plurality of submatrices, and generating the second matrix representing, for each of the submatrices, the second element group that includes the non-zero elements that, among the elements in at least a part of rows, form the submatrix, other than the elements on the part of diagonals.

7. The recording medium according to claim 1, wherein
the first format is a Diagonal format,
the second format is an ELLpack format,
the information processing program further comprises an instruction for generating a third matrix in a Compressed Sparse Row format, the third matrix representing a third element group that includes the non-zero elements that are among the elements that form the obtained matrix, other than the elements on the part of diagonals, and that are in a part of rows or columns whose numbers of the non-zero elements are each at least equal to a third number, and
the instruction for generating the second matrix includes generating the second matrix representing the second element group that includes the non-zero elements that are among the elements that form the obtained matrix, other than the elements on the part of diagonals, and that are in a part of rows or columns whose numbers of the non-zero elements are each fewer than the third number.

8. The recording medium according to claim 1, wherein
the instruction for generating the second matrix includes generating the second matrix such that rows or columns forming the second matrix do not include rows or columns representing the elements in rows or columns that form the obtained matrix and that each having no non-zero element present therein.

9. The recording medium according to claim 1, wherein
the instruction for generating the second matrix includes generating the second matrix representing the second element group that includes the non-zero elements among the elements in all rows or all columns that form the obtained matrix, other than the elements lining on the part of diagonals.

10. The recording medium according to claim 1, wherein
the calculation for the matrix vector multiplication calculates a matrix vector multiplication of the obtained matrix and a predetermined vector, and
the information processing program further comprises an instruction for executing the calculation for the matrix vector multiplication, based on the generated first matrix and the generated second matrix using a function of prefetching a portion of the vector.

11. The recording medium according to claim 1, wherein
the matrix subject to the calculation is a matrix having sparseness.

12. An information processing method executed by a computer, the method comprising:
obtaining a matrix to be subject to a calculation for a matrix vector multiplication;
generating a first matrix in a first format, the first matrix representing a first element group that includes non-zero elements among elements on a part of diagonals, among a main diagonal and sub-diagonals parallel to the main diagonal in the obtained matrix; and
generating a second matrix in a second format different from the first format, the second matrix representing a second element group that includes the non-zero elements, among the elements in at least a part of rows or columns that form the obtained matrix, other than the elements on the part of the diagonals.
